(19) United States
(12) Patent Application Publication
(10) Pub. No.: US 2016/0252069 A1
(43) Pub. Date: Sep. 1, 2016

(54) HYBRID VEHICLE, CONTROLLER FOR A VARIABLE VALVE TIMING (LIFT AND/OR ANGLE) DEVICE FOR THE COMBUSTION ENGINE OF THE HYBRID VEHICLE, AND CONTROL METHOD FOR SUCH HYBRID VEHICLE

(71) Applicant: TOYOTA JIDOSHA KABUSHIKI KAISHA, Toyota-shi (JP)

(72) Inventors: Ryuta Teraya, Okazaki-shi (JP); Yoshikazu Asami, Gotenba-shi (JP); Toshikazu Kato, Toyota-shi (JP)

(73) Assignee: Toyota Jidosha Kabushiki Kaisha, Toyota-shi (JP)

(21) Appl. No.: 15/029,705

(22) PCT Filed: Oct. 2, 2014
(86) PCT No.: PCT/IB2014/002011

§ 371 Date: Apr. 15, 2016

(30) Foreign Application Priority Data
Oct. 16, 2013 (JP) 2013-215455

(51) Int. Cl. F02N 19/00; B60W 10/08; B60K 6/24; B60W 20/13; B60K 6/44; B60K 6/46; F02D 13/02; B60W 10/06

(52) U.S. Cl. CPC F02N 19/004; F02D 13/0223; B60W 10/08; B60W 10/06; B60W 20/13; B60K 6/44; B60K 6/46; B60K 6/24; B60W 2710/0605; B60W 2710/08; Y10S 903/93; Y10S 903/905; B60Y 2200/92; B60Y 2300/437

(57) ABSTRACT

A hybrid vehicle includes a rotary electric machine, an internal combustion engine, and a controller. The rotary electric machine generates driving force for the hybrid vehicle. The internal combustion engine includes a variable valve actuating device configured to change an operation characteristic of an intake valve. The controller controls travel of the vehicle by selectively applying one of a first driving mode and a second driving mode. The controller controls the variable valve actuating device such that at least one of a valve lift of the intake valve and a valve operating angle of the intake valve at start-up of the internal combustion engine when the first driving mode is selected is smaller than the corresponding at least one of the valve lift of the intake valve and the valve operating angle of the intake valve at start-up of the internal combustion engine when the second driving mode is selected.

### BACKGROUND

1. Field

The disclosure relates to a hybrid vehicle, a controller for a hybrid vehicle, and a control method for a hybrid vehicle and, more particularly, to a hybrid vehicle that includes an internal combustion engine including a variable valve actuating device for changing the operation characteristic of an intake valve, a controller for the hybrid vehicle, and a control method for the hybrid vehicle.

2. Description of Related Art

There is known an internal combustion engine including a variable valve actuating device that is able to change the operation characteristic of an intake valve. There is also known a variable valve actuating device that is able to change at least one of the valve lift and valve operating angle of an intake valve as such a variable valve actuating device (see Japanese Patent Application Publication No. 2005-299594 (JP 2005-299594 A), Japanese Patent Application Publication No. 2004-183610 (JP 2004-183610 A), Japanese Patent Application Publication No. 2013-53610 (JP 2013-53610 A), Japanese Patent Application Publication No. 2008-25550 (JP 2008-25550 A), Japanese Patent Application Publication No. 2012-117376 (JP 2012-117376 A), Japanese Patent Application Publication No. 9-242519 (JP 9-242519 A), and the like).

For example, JP 2005-299594 A describes a variable valve actuating device that is able to change the valve lift and valve operating angle of each intake valve of an internal combustion engine. In this variable valve actuating device, when the internal combustion engine is automatically stopped on the assumption that the internal combustion engine is restarted in a relatively short time, the valve operating angle of each intake valve during engine stop is set to a maximum operating angle in order to fully obtain decompression. In contrast, when the internal combustion engine is manually stopped, a target valve operating angle during engine stop is set to a value smaller than that when the engine is automatically stopped in order to handle both high-temperature start-up and low-temperature start-up, thus giving a higher priority to startability of the engine.

On the other hand, in a hybrid vehicle in which a driving electric motor is mounted in addition to an internal combustion engine, one of a driving mode in which only the electric motor is used and a driving mode in which the internal combustion engine is operated is selectively applied. Thus, there have been suggested various methods for efficiently controlling an internal combustion engine mounted on a hybrid vehicle (see, for example, International Application Publication No. 2012/131941, Japanese Patent Application Publication No. 2013-129380 (JP 2013-129380 A), Japanese Patent Application Publication No. 2008-308138 (JP 2008-308138 A), Japanese Patent Application Publication No. 2010-285038 (JP 2010-285038 A), and the like).

In the hybrid vehicle, start-up and stop of the internal combustion engine are automatically controlled on the basis of a traveling state, so the process of starting up the internal combustion engine frequently occurs. Particularly, the inside of a vehicle cabin is quiet while the hybrid vehicle is travelling by using only the electric motor. Therefore, vibrations and noise resulting from start-up of the internal combustion engine are easily experienced by a user. Thus, the technique described in JP 2005-299594 A is useful for a hybrid vehicle in terms of suppressing vibrations at start-up of an internal combustion engine.

On the other hand, as described in International Application Publication No. 2012/131941, a hybrid vehicle is controlled so that an internal combustion engine is intermittently operated in response to high output of the vehicle. However, in control over the characteristic of each intake valve according to JP 2005-299594 A, the operation characteristic of each intake valve for fully obtaining decompression is uniformly set at automatic stop of the internal combustion engine.

Thus, if control over the characteristic of each intake valve according to JP 2005-299594 A is merely applied to a hybrid vehicle, the operation characteristic of each intake valve is uniformly set so that decompression is fully obtained at automatic stop of the internal combustion engine, so there is a concern that the acceleration performance of the vehicle decreases at start-up of the internal combustion engine.

### SUMMARY

The disclosure is to control the operation characteristic of an intake valve at start-up of an internal combustion engine so that an output characteristic and vibration suppression at start-up of the internal combustion engine are appropriately ensured.

A first aspect of the disclosure provides a hybrid vehicle. The hybrid vehicle includes a rotary electric machine, an internal combustion engine, and a controller. The rotary electric machine is configured to generate driving force for the hybrid vehicle. The internal combustion engine includes a variable valve actuating device configured to change an operation characteristic of an intake valve. The controller is configured to control travel of the vehicle by selectively applying one of a first driving mode and a second driving mode. The controller is configured to control the variable valve actuating device such that at least one of a valve lift of the intake valve and a valve operating angle of the intake valve at start-up of the internal combustion engine when the first driving mode is selected is smaller than the corresponding at least one of the valve lift of the intake valve and the valve operating angle of the intake valve at start-up of the internal combustion engine when the second driving mode is selected. The frequency of start-up of the internal combustion engine in a start-up condition in the second driving mode is higher than the frequency of start-up of the internal combustion engine in the start-up condition in the first driving mode. The start-up condition is a condition for starting up the internal combustion engine in a stopped state.

With the hybrid vehicle, under the condition that one of the first and second driving modes having different frequencies of start-up of the internal combustion engine is selectively applied, it is possible to control at least one of the valve lift of the intake valve and the valve operating angle of the intake valve at start-up of the internal combustion engine in correspondence with the selected one of the first driving mode and the second driving mode. Specifically, when the second driving mode in which the frequency of start-up of the internal combustion engine is high is selected, vibration suppression at start-up of the internal combustion engine is given a higher priority. On the other hand, when the first driving mode in which the frequency of start-up of the internal combustion engine is low is selected, output response (torque response) at start-up of the internal combustion engine is given a higher priority. In this manner, it is possible to control the operation characteristic (at least one of the valve lift and the valve operating angle) of the intake valve. As a result, it is possible to appropriately ensure output characteristic and vibration suppression at start-up of the internal combustion engine.

In the above aspect, the controller may be configured to, when the first driving mode is selected, start up the internal combustion engine when an output parameter of the vehicle exceeds a first threshold. The controller may be configured to, when the second driving mode is selected, start up the internal combustion engine when the output parameter of the vehicle exceeds a second threshold. The second threshold may be lower than the first threshold, the output parameter of the vehicle may be calculated at least on the basis of an accelerator pedal operation amount.

With this configuration, when the first driving mode in which a threshold for starting up the internal combustion engine is high and high output tends to be required of the vehicle at start-up of the internal combustion engine is selected, it is possible to give a higher priority to output response (torque response) by reducing at least one of the valve lift of the intake valve and the valve operating angle of the intake valve. Therefore, it is possible to quickly ensure an output required of the internal combustion engine.

In the above aspect, the variable valve actuating device may be configured to change the operation characteristic of the intake valve to one of a first characteristic and a second characteristic. The controller may be configured to, when the first driving mode is selected, control the variable valve actuating device such that the operation characteristic of the intake valve is set to the first characteristic at start-up of the internal combustion engine. The controller may be configured to, when the second driving mode is selected, control the variable valve actuating device such that the operation characteristic of the intake valve is set to the second characteristic at start-up of the internal combustion engine. At least one of the valve lift of the intake valve and the valve operating angle of the intake valve in the second characteristic may be larger than the corresponding at least one of the valve lift of the intake valve and the valve operating angle of the intake valve in the first characteristic.

With this configuration, it is possible to appropriately control the operation characteristic of the intake valve at start-up of the internal combustion engine as described above on the basis of the driving mode of the hybrid vehicle with the variable valve actuating device by which the operation characteristic (at least one of the valve lift and the valve operating angle) of the intake valve is limited to two steps. Thus, it is possible to simplify the configuration of the variable valve actuating device and to shorten a time that is required to adapt control parameters of the internal combustion engine.

In the above aspect, the variable valve actuating device may be configured to change the operation characteristic of the intake valve to any one of a first characteristic, a second characteristic and a third characteristic. The controller may be configured to, when the first driving mode is selected, control the variable valve actuating device such that the operation characteristic of the intake valve is set to the first characteristic at start-up of the internal combustion engine. The controller may be configured to, when the second driving mode is selected, control the variable valve actuating device such that the operation characteristic of the intake valve is set to the third characteristic at start-up of the internal combustion engine. At least one of the valve lift of the intake valve and the valve operating angle of the intake valve in the second characteristic may be larger than the corresponding at least one of the valve lift of the intake valve and the valve operating angle of the intake valve in the first characteristic. At least one of the valve lift of the intake valve and the valve operating angle of the intake valve in the third characteristic may be larger than the corresponding at least one of the valve lift of the intake valve and the valve operating angle of the intake valve in the second characteristic.

With this configuration, it is possible to appropriately control the operation characteristic of the intake valve at start-up of the internal combustion engine as described above on the basis of the driving mode of the hybrid vehicle with the variable valve actuating device by which the operation characteristic (at least one of the valve lift and the valve operating angle) of the intake valve is limited to three steps. Thus, it is possible to simplify the configuration of the variable valve actuating device and to shorten a time that is required to adapt control parameters of the internal combustion engine. In comparison with the configuration that the operation characteristic of the intake valve is limited to two steps, it is possible to precisely control the internal combustion engine.

In the above aspect, the controller may be configured to, when a process of stopping the internal combustion engine is executed, control the variable valve actuating device such that at least one of the valve lift of the intake valve and the valve operating angle of the intake valve when the first driving mode is selected is smaller than the corresponding at least one of the valve lift of the intake valve and the valve operating angle of the intake valve when the second driving mode is selected.

With this configuration, it is possible to appropriately control the operation characteristic of the intake valve at start-up of the internal combustion engine as described above on the basis of the driving mode of the hybrid vehicle even when the variable valve actuating device that is difficult to change the operation characteristic (at least one of the valve lift and the valve operating angle) of the intake valve at engine start-up process is employed.

In the above aspect, the controller may be configured to, when a process of stopping the internal combustion engine is executed, predict a driving mode that is selected at the next start-up of the internal combustion engine, and predict the driving mode on the basis of a condition of the vehicle and a driving mode that is selected at the time when the process of stopping the internal combustion engine is executed. The controller may be configured to control the variable valve actuating device during the process of stopping the internal combustion engine such that at least one of the valve lift of the intake valve and the valve operating angle of the intake valve when the predicted driving mode is the first driving mode is smaller than the corresponding at least one of the valve lift of the intake valve and the valve operating angle of the intake valve when the predicted driving mode is the second driving mode.

With this configuration, it is possible to predict a change in the driving mode during stop of the internal combustion engine even when the variable valve actuating device that is difficult to change the operation characteristic (at least one of the valve lift and the valve operating angle) of the intake valve at engine start-up process is employed. Therefore, it is possible to appropriately control the operation characteristic of the intake valve at start-up of the internal combustion engine on the basis of the driving mode.

In the above aspect, the controller may be configured to, when a process of starting up the internal combustion engine is executed, control the variable valve actuating device such that at least one of the valve lift of the intake valve and the valve operating angle of the intake valve when the first driving mode is selected is smaller than the corresponding at least one of the valve lift of the intake valve and the valve operating angle of the intake valve when the second driving mode is selected.

With this configuration, it is possible to appropriately control the operation characteristic of the intake valve in correspondence with the driving mode (CD mode/CS mode) at start-up of the internal combustion engine when the variable valve actuating device that is able to change the operation characteristic (at least one of the valve lift and the valve operating angle) of the intake valve at engine start-up process is employed.

In the above aspect, the hybrid vehicle may further include an electrical storage device and a power generating mechanism. The electrical storage device is configured to store electric power for driving the rotary electric machine. The power generating mechanism is configured to generate electric power for charging the electrical storage device by using output of the internal combustion engine. The controller may be configured to, when the second driving mode is selected, control travel of the vehicle such that an SOC of the electrical storage device is kept while the internal combustion engine is operated. The controller may be configured to, when the first driving mode is selected, control travel of the vehicle such that the SOC decreases with an increase in travel distance.

With this configuration, when the second driving mode in which the frequency of start-up of the internal combustion engine increases for charging the electrical storage device is selected, it is possible to suppress vibrations at start-up of the internal combustion engine by increasing at least one of the valve lift of the intake valve and the valve operating angle of the intake valve as compared to when the first driving mode (CD mode) is selected.

In the above aspect, the hybrid vehicle may further include an electrical storage device and a power generating mechanism. The electrical storage device is configured to store electric power for driving the rotary electric machine. The power generating mechanism is configured to generate electric power for charging the electrical storage device by using output of the internal combustion engine. The controller may be configured to select the first driving mode when an SOC of the electrical storage device is higher than a determination value. The controller may be configured to select the second driving mode when the SOC of the electrical storage device is lower than the determination value.

In the above aspect, the controller may be configured to, when the second driving mode is selected, control travel of the vehicle such that the SOC of the electrical storage device is kept within a target range by operating the internal combustion engine. The controller may be configured to, when the first driving mode is selected, control travel of the vehicle without operating the internal combustion engine for increasing the SOC.

With this configuration, the hybrid vehicle is able to travel by selecting the first driving mode and actively using energy of the electrical storage device by suppressing the frequency of start-up of the internal combustion engine in a region in which the SOC is high. As a result, it is possible to improve a fuel consumption amount and an emission amount.

In the above aspect, the hybrid vehicle may further include an operation switch. The operation switch is configured to allow a user to directly select one of the first driving mode and the second driving mode. The controller may be configured to, when the operation switch is operated by the user, select one of the first driving mode and the second driving mode by giving a higher priority to input based on operation of the operation switch than selection based on the SOC.

With this configuration, when the user directly selects one of the first driving mode and the second driving mode with the operation switch as well, it is possible to appropriately control the operation characteristic (at least one of the valve lift and the valve operating angle) of the intake valve at start-up of the internal combustion engine as described above on the basis of the selected driving mode.

Another aspect of the disclosure provides a controller for a hybrid vehicle. The hybrid vehicle including a rotary electric machine and an internal combustion engine. The rotary electric machine is configured to generate driving force for the vehicle. The internal combustion engine includes a variable valve actuating device configured to change an operation characteristic of an intake valve. The controller includes first control means and second control means. The first control means is configured to control travel of the vehicle by selectively applying one of a first driving mode and a second driving mode. The second control means is configured to control the variable valve actuating device such that at least one of a valve lift of the intake valve and a valve operating angle of the intake valve at start-up of the internal combustion engine when the first driving mode is selected is smaller than the corresponding at least one of the valve lift of the intake valve and the valve operating angle of the intake valve at start-up of the internal combustion engine when the second driving mode is selected. The frequency of start-up of the internal combustion engine in a start-up condition in the second driving mode is higher than the frequency of start-up of the internal combustion engine in the start-up condition in the first driving mode. The start-up condition is a condition for starting up the internal combustion engine in a stopped state.

Further another aspect of the disclosure provides a control method for a hybrid vehicle. The hybrid vehicle includes a rotary electric machine, an internal combustion engine, and a controller. The rotary electric machine is configured to generate driving force for the vehicle. The internal combustion engine includes a variable valve actuating device configured to change an operation characteristic of an intake valve. The control method includes: (a) controlling, by the controller, travel of the vehicle by selectively applying one of a first driving mode and a second driving mode; and (b) controlling, by the controller, the variable valve actuating device such that at least one of a valve lift of the intake valve and a valve operating angle of the intake valve at start-up of the internal combustion engine when the first driving mode is selected is smaller than the corresponding at least one of the valve lift of the intake valve and the valve operating angle of the intake valve at start-up of the internal combustion engine when the second driving mode is selected. The frequency of start-up of the internal combustion engine in a start-up condition in the second driving mode is higher than the frequency of start-up of the internal combustion engine in the start-up condition in the first driving mode. The start-up condition is a condition for starting up the internal combustion engine in a stopped state.

According to the disclosure, it is possible to control the operation characteristic of the intake valve at start-up of the internal combustion engine so that an output characteristic and vibration suppression are appropriately ensured.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram that shows the overall configuration of a hybrid vehicle according to an embodiment of the disclosure;

FIG. 2 is a conceptual waveform chart for illustrating a typical example of changes in mode of the hybrid vehicle and SOC;

FIG. 3 is a conceptual waveform chart for illustrating an example of changes in mode and SOC when a user operates an operation switch;

FIG. 4 is a conceptual waveform chart for illustrating an operation example of returning from a CS mode to a CD mode;

FIG. 5 is an operation waveform chart for illustrating control over operation and stop of an engine in the CD mode and the CS mode;

FIG. 6 is a configuration view of the engine shown in FIG. 1;

FIG. 7 is a graph that shows the correlation between a crank angle and a valve displacement that is achieved by a VVL device;

FIG. 8 is a front view of the VVL device;

FIG. 9 is a perspective view that partially shows the VVL device shown in FIG. 8;

FIG. 10 is a conceptual view that illustrates an operation at the time when the valve lift and valve operating angle of each intake valve are large;

FIG. 11 is a conceptual view that illustrates an operation at the time when the valve lift and valve operating angle of each intake valve are small;

FIG. 12 is a graph that shows the correlation between the operation characteristic of each intake valve and the response of engine torque;

FIG. 13 is a graph that shows the correlation between the operation characteristic of each intake valve and a temporal change in engine rotation speed at engine start-up;

FIG. 14 is a table that illustrates setting of the operation characteristic of each intake valve in engine start-up process in the hybrid vehicle according to the first embodiment;

FIG. 15 is a flowchart that illustrates the control structure of intake valve control in the hybrid vehicle according to the first embodiment;

FIG. 16 is a flowchart that illustrates the control structure of intake valve control in the hybrid vehicle according to an alternative embodiment to the first embodiment;

FIG. 17 is a flowchart that illustrates a control process for predicting a mode at the next engine start-up;

FIG. 18 is a flowchart that illustrates the control structure of intake valve control in the hybrid vehicle according to a second embodiment;

FIG. 19 is a graph that shows the correlation between a crank angle and a valve displacement that is achieved by a VVL device that is able to change the operation characteristic of each intake valve in three steps;

FIG. 20 is a graph that shows an operating line of an engine including the VVL device having operation characteristics shown in FIG. 19;

FIG. 21 is a flowchart that shows the control structure of intake valve control according to the first embodiment by applying the VVL device having the operation characteristics shown in FIG. 19;

FIG. 22 is a flowchart that shows the control structure of intake valve control according to the alternative embodiment to the first embodiment by applying the VVL device having the operation characteristics shown in FIG. 19;

FIG. 23 is a flowchart that shows the control structure of intake valve control according to the second embodiment by applying the VVL device having the operation characteristics shown in FIG. 19; and

FIG. 24 is a graph that shows the correlation between a crank angle and a valve displacement that is achieved by a VVL device that is able to change the operation characteristic of each intake valve in two steps.

### DETAILED DESCRIPTION OF EMBODIMENTS

Hereinafter, embodiments of the disclosure will be described in detail with reference to the accompanying drawings. Although the plurality of embodiments will be described below, appropriate combinations of the configurations described in the embodiments are expected at the time of filing. Like reference numerals denote the same or corresponding portions in the drawings, and the description thereof will not be repeated in principle.

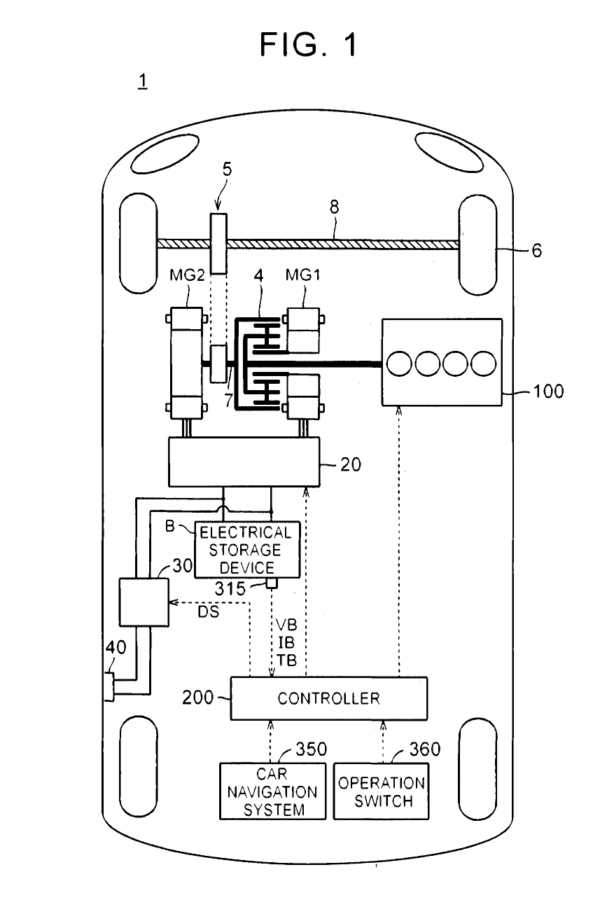

FIG. 1 is a block diagram that shows the overall configuration of a hybrid vehicle according to an embodiment of the disclosure.

As shown in FIG. 1, the hybrid vehicle 1 includes an engine 100, motor generators MG1, MG2, a power split device 4, a reduction gear 5, and drive wheels 6. The hybrid vehicle 1 further includes an electrical storage device B, a PCU 20, a power converter 30, an external inlet 40 and a controller 200.

The engine 100 is, for example, an internal combustion engine, such as a gasoline engine and a diesel engine. The engine 100 includes a variable valve actuating device for changing the operation characteristic of each intake valve. The configuration of the engine 100 and variable valve actuating device will be described in detail later.

The power split device 4 is configured to be able to split power, which is generated by the engine 100, into a path toward a drive shaft 8 via an output shaft 7 and a path toward the motor generator MG1. The power split device 4 may be formed of a planetary gear train. The planetary gear train includes three rotary shafts, that is, a sun gear, a planetary gear and a ring gear. For example, the rotor of the motor generator MG1 is connected to the sun gear, the output shaft of the engine 100 is connected to the planetary gear, and the output shaft 7 is connected to the ring gear. Thus, the engine 100 and the motor generators MG1, MG2 are allowed to be mechanically connected to the power split device 4.

The output shaft 7 is also connected to the rotor of the motor generator MG2. The output shaft 7 is mechanically coupled to the drive shaft 8 via the reduction gear 5. The drive shaft 8 is used to rotationally drive the drive wheels 6. A transmission may be further assembled between the rotary shaft of the motor generator MG2 and the output shaft 7.

Each of the motor generators MG1, MG2 is an alternating-current rotary electric machine, and is, for example, a three-phase alternating-current synchronous motor generator. The motor generator MG1 operates as a generator by using the driving force of the engine 100. The driving force is transmitted via the power split device 4. That is, the hybrid vehicle 1 is able to generate electric power with the motor generator MG1 by using the output of the engine 100 even while traveling. Electric power generated by the motor generator MG1 is converted in voltage by the PCU 20, and stored in the electrical storage device B or directly supplied to the motor generator MG2. In this way, while the hybrid vehicle 1 is traveling as well, the hybrid vehicle 1 is able to generate electric power for charging the electrical storage device B by operating the engine 100.

The motor generator MG2 generates driving force by using at least one of electric power stored in the electrical storage device B and electric power generated by the motor generator MG1. Driving force of the motor generator MG2 is transmitted to the drive wheels 6 via the output shaft 7, the reduction gear 5 and the drive shaft 8. In FIG. 1, the drive wheels 6 are front wheels. Instead of the front wheels or in addition to the front wheels, rear wheels may be driven by the motor generator MG2.

During braking of the hybrid vehicle 1, the motor generator MG2 is driven through the reduction gear 5, the drive shaft 8 and the output shaft 7, and the motor generator MG2 operates as a generator. Thus, the motor generator MG2 operates as a regenerative brake that converts braking energy to electric power. Electric power generated by the motor generator MG1 is converted in voltage by the PCU 20, and is allowed to be stored in the electrical storage device B.

The PCU 20 converts direct-current power, which is supplied from the electrical storage device B, to alternating-current power, and drives the motor generators MG1, MG2 by using the alternating-current power. The PCU 20 converts alternating-current power, generated by the motor generators MG1, MG2, to direct-current power, and charges the electrical storage device B with the direct-current power. For example, the PCU 20 includes an inverter (not shown) and a converter (not shown). The inverter is used to convert between direct-current power and alternating-current power. The converter is used to convert direct-current voltage between a direct-current link side of the inverter and the electrical storage device B.

The electrical storage device B is an electric power storage element configured to be rechargeable. The electrical storage device B is configured to include a secondary battery, such as a lithium ion battery, a nickel-metal hydride battery and a lead storage battery, or a cell of an electrical storage element, such as an electric double layer capacitor. A sensor 315 is provided at the electrical storage device B. The sensor 315 is used to detect the temperature, current and voltage of the electrical storage device B. Values detected by the sensor 315 are output to the controller 200. The controller 200 calculates a state of charge (hereinafter, also referred to as “SOC”) of the electrical storage device B on the basis of the values detected by the sensor 315.

The external inlet 40 is an electric power interface with a device outside the hybrid vehicle 1. The power converter 30 carries out power conversion between the external inlet 40 and the electrical storage device B. The power converter 30 is operated by a driving signal DS from the controller 200.

For example, during external charging, a power supply outside the vehicle (for example, a commercial system power supply) is connected to the external inlet 40 of the hybrid vehicle 1. During external charging, the controller 200 generates the driving signal DS such that the power converter 30 converts electric power (for example, 100 VAC or 200 VAC) from the external power supply to electric power (for example, 200 VDC) for charging the electrical storage device B. Thus, the electrical storage device B of the hybrid vehicle 1 is allowed to be charged (externally charged) with the power supply outside the vehicle.

The power converter 30 may be configured to bidirectionally convert electric power, and feed electric power to a device outside the vehicle by converting electric power stored in the electrical storage device B to electric power equivalent to the external power supply. During external power feeding of the hybrid vehicle 1, it is possible to supply electric power from the external inlet 40 to a device outside the vehicle. During external power feeding, electric power generated by the motor generator MG1 through operation of the engine 100 may be supplied to the power converter 30.

A car navigation system 350 is mounted on the hybrid vehicle 1. The car navigation system 350 may be configured to be communicable with a device outside the vehicle, and to acquire host vehicle positional information, that is, the current location of the hybrid vehicle 1, with a global positioning system (GPS). The GPS measures a vehicle location by utilizing artificial satellites. The car navigation system 350 is also able to provide traveling guidance to the vehicle by loading road map data and combining the acquired host vehicle positional information with road map information. The road map data is recorded in a storage medium, such as a digital versatile disc (DVD) (not shown). For example, the host vehicle location may be displayed on a display unit (not shown) by superimposing the host vehicle location on the road map data.

When a destination is set by a user, the car navigation system 350 is able to search for a travel route from the current location to the destination and to provide route guidance with the display unit (not shown). The car navigation system 350 is generally configured to have the function of storing a travel history of the hybrid vehicle 1. Thus, the car navigation system 350 is able to learn a past travel history, and the like, on each road. When information about home, office, and the like, is registered in the car navigation system 350, the car navigation system 350 is able to recognize a specific region (region within a set distance from a specific destination) on the basis of the relationship with such a specific destination.

The controller 200 is typically formed of an electronic control unit (ECU). The ECU mainly includes a central processing unit (CPU), a memory region, such as a random access memory (RAM) and a read only memory (RAM). The controller 200 executes control associated with vehicle traveling and charge/discharge operation in the following manner. The CPU loads a program prestored in the ROM, or the like, and executes the program. At least part of the ECU may be configured to execute predetermined numeric/logical arithmetic processing by hardware, such as an electronic circuit.

The controller 200 controls the outputs of the engine 100 and motor generators MG1, MG2 on the basis of the traveling state of the vehicle. Particularly, the controller 200 controls the driving mode of the hybrid vehicle 1 so as to combine an “EV mode” with an “HV mode”. In the “EV mode”, the vehicle travels by using the output of the motor generator MG2 in a state where the engine 100 is stopped. In the “HV mode”, the vehicle travels in a state where the engine 100 is operated.

Traveling control over the hybrid vehicle 1 will be described in further details.

In the hybrid vehicle 1, as part of traveling control, a driving mode is changed between a charge sustaining (CS) mode and a charge depleting (CD) mode. In the CS mode, the SOC of the electrical storage device B is kept at a constant level. In the CD mode, the vehicle travels by actively using energy of the electrical storage device B. As will be apparent from the following description, the CD mode corresponds to a “first driving mode”, and the CS mode corresponds to a “second driving mode”.

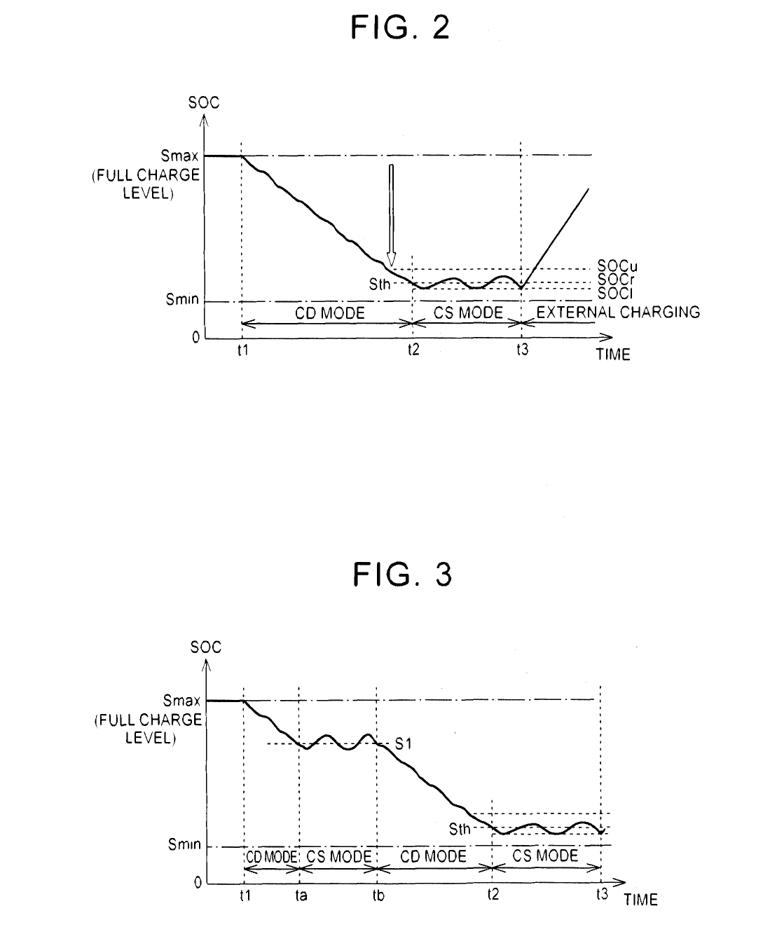

FIG. 2 is a conceptual waveform chart for illustrating a typical example of changes in mode and SOC in the hybrid vehicle 1.

As shown in FIG. 2, in the CS mode, the hybrid vehicle 1 is controlled so that the SOC is kept, for example, the SOC is kept within the range of SOC1 to SOCu including a control center SOCr. That is, in the CS mode, not only the electrical storage device B is charged through regenerative power generation during deceleration of the vehicle but also the electrical storage device B is charged with electric power generated by using the output of the engine 100 in order to increase the SOC. Specifically, when the SOC decreases below the control center SOCr, the engine 100 is operated in order to charge the electrical storage device B. At this time, the engine 100 is controlled so as to output a power for charging the electrical storage device B in addition to a power for propelling the vehicle. That is, in the CS mode, even in a condition that a vehicle traveling power is allowed to be ensured in the EV mode, such as at a low speed, there is a possibility that the engine 100 is operated in order to charge the electrical storage device B.

In contrast, in the CD mode, travel of the hybrid vehicle 1 is controlled so that the SOC decreases with an increase in travel distance without keeping the SOC. In the CD mode, the electrical storage device B is charged through only regenerative power generation during deceleration of the vehicle, and the operation of the engine 100 for charging the electrical storage device B is avoided.

However, in the CD mode as well, the engine 100 can be operated at the time of warm-up of the engine and the catalyst or during operation of an engine-driven air conditioner. As will be described later, even in a situation in which high output is required of the vehicle as a result of large depression of an accelerator pedal, the engine 100 can be operated. However, in the CD mode, the opportunity of traveling in the EV mode increases as compared to the CS mode, so the frequency of operation of the engine 100 decreases. As a result, in the CD mode, the hybrid vehicle 1 travels by actively using energy stored in the electrical storage device B. For example, in the hybrid vehicle having an external charging function as shown in FIG. 1, it is possible to improve fuel economy and the amount of emissions by actively applying the CD mode.

As shown in FIG. 2, for example, the mode (driving mode) is selected on the basis of the SOC. Specifically, the CD mode is selected when the SOC is higher than a determination value Sth, whereas the CS mode is selected when the SOC becomes lower than the determination value Sth in the case of the CD mode selected.

In the example shown in FIG. 2, at the beginning of traveling (time t1), the hybrid vehicle 1 is placed in a state where the electrical storage device B is charged to a full charge level as a result of external charging (SOC=Smax). In addition, because SOC>Sth, the CD mode is selected.

In the CD mode, because the frequency of operation of the engine 100 is suppressed to a lesser degree and the frequency of traveling in the EV mode is increased, the SOC gradually decreases with an increase in travel distance except during recovery of energy through regenerative braking. When SOC<Sth, the hybrid vehicle 1 is changed from the CD mode to the CS mode (time t2).

In the CS mode from time t2, when the SOC decreases, the engine 100 is operated in order to charge the electrical storage device B, with the result that the SOC is kept within a set range (SOC1 to SOCu).

When travel of the vehicle ends, the user connects the external power supply to the external inlet 40, with the result that external charging is started (time t3). Owing to external charging, the SOC of the electrical storage device B begins to increase. When the SOC reaches the full charge level (Smax), external charging completes, and the state before time t1 is reproduced.

Referring back to FIG. 1, the hybrid vehicle 1 may include an operation switch 360 for allowing the user to directly select the mode (CD/CS). That is, when the operation switch 360 is operated by the user, the mode is selected by giving a higher priority to user's operation. As an example, the operation switch 360 is configured to allow the user to carry out input operation for directly selecting the CS mode in order to keep the SOC even in the CD mode. Alternatively, the operation switch 360 may be provided on the condition that the SOC falls within a set SOC range, or the like, so that the user is allowed to carry out input operation for directly selecting the CD mode.

FIG. 3 shows an example of changes in mode and SOC at the time when the user operates the operation switch 360.

As shown in FIG. 3, travel of the hybrid vehicle 1 is started from time t1 as in the case of FIG. 2, the CS mode is selected through user's operation of the operation switch 360 at time ta during traveling in the CD mode. At time tb, the user operates the operation switch 360 again, with the result that the CS mode selected by the user is cancelled. Thus, the CD mode is selected on the basis of the current SOC (SOC<Sth).

In a period of time ta to time tb, the CS mode is selected, and traveling control over the hybrid vehicle 1 is executed so that the SOC (S1) at the timing (time ta) of operation of the operation switch 360 is kept. That is, when the SOC decreases below S1 by a predetermined value, the engine 100 is operated in order to generate electric power for charging the electrical storage device B.

In a period between time tb to time t2, as in the case of the period between time t1 to time ta, the SOC gradually decreases with an increase in travel distance. When SOC<Sth (time t2), as in the case of FIG. 2, the hybrid vehicle 1 travels in the CS mode.

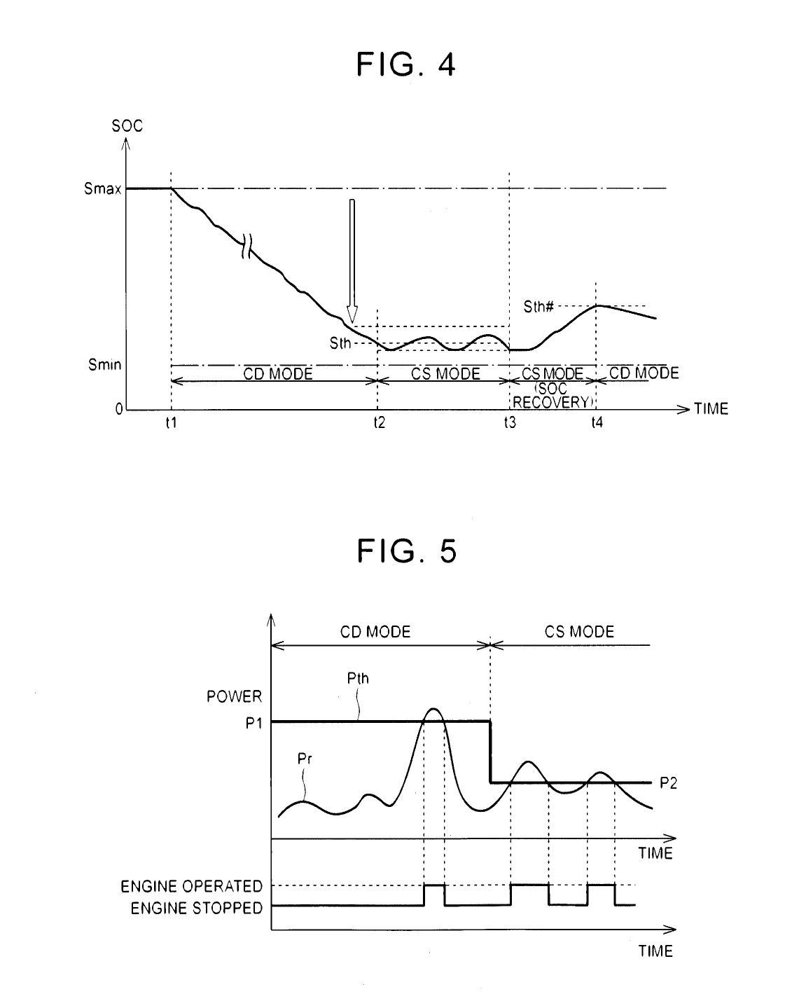

As shown in FIG. 4, as a result of an increase in the SOC during the CS mode, it is allowed to select the CD mode again.

As shown in FIG. 4, after time t3, when the vehicle has traveled on a downhill over a relatively long distance, charging of the electrical storage device B is continued through regenerative braking, with the result that the SOC increases. At this time, when the SOC exceeds a determination value Sth#, the CD mode is selected again (time t4).

The determination value Sth is a threshold for determining whether to change from the CD mode to the CS mode. The determination value Sth# is a threshold for determining whether to change from the CS mode to the CD mode. By setting the determination values such that Sth#>Sth, it is possible to prevent frequent change between the CD mode and the CS mode.

After time t4, the hybrid vehicle 1 travels in the CD mode, and the SOC gradually decreases again. When the SOC decreases below the determination value Sth again, the hybrid vehicle 1 is changed from the CD mode to the CS mode.

Alternatively, an “SOC recovery switch” for forcibly increasing the SOC may be provided as the operation switch 360 shown in FIG. 1. When the SOC recovery switch is operated, the CS mode is forcibly selected, so the control center SOCr (FIG. 2) of the SOC is set to a value higher than the current SOC. The control center SOCr at this time may be directly specified by the user or may be set in accordance with a predetermined value set in advance. During an on state of the SOC recovery switch (operation switch 360), the CS mode is selected. However, after the SOC recovery switch is turned off, the mode is selected on the basis of the SOC. That is, when SOC>Sth#, the hybrid vehicle 1 is changed from the CS mode to the CD mode.

The hybrid vehicle 1 travels with engine intermittent operation in each of the CD mode and the CS mode. In engine intermittent operation, operation and stop of the engine 100 are controlled. More specifically, the engine 100 is intermittently operated in response to high output of the hybrid vehicle 1.

FIG. 5 is an operation waveform chart for illustrating control over operation and stop of the engine in each of the CD mode and the CS mode.

As shown in FIG. 5, in each of the CD mode and the CS mode, in the hybrid vehicle 1, start-up and stop of the engine are controlled on the basis of a comparison between an output parameter Pr and a threshold Pth. The output parameter Pr quantitatively indicates an output (power or torque) that is required of the hybrid vehicle 1.

For example, the output parameter Pr is a total required power Ptl of the hybrid vehicle 1. The total required power Ptl is allowed to be calculated from the sum of a required driving power Pr* and a required charge/discharge power Pchg (Ptl=Pr*+Pchg). The required driving power Pr* is expressed by the product of a required torque Tr* and the rotation speed of the drive shaft 8. The required torque Tr* reflects a driver's accelerator pedal operation amount. The required charge/discharge power Pchg is used to control the SOC of the electrical storage device B.

The required torque Tr* is set to a higher value as the accelerator pedal operation amount increases. In combination with the vehicle speed, it is desirable to set the required torque Tr* such that the required torque Tr* decreases as the vehicle speed increases for the same accelerator operation amount. It is applicable to previously create a map by reflecting these characteristics. The required torque Tr* is set on the basis of an accelerator pedal operation amount and the vehicle speed by using the map.

The required charge/discharge power Pchg is set to zero in the CD mode in which the SOC is not kept (Pchg=0). On the other hand, in the CS mode, on the basis of the SOC, Pchg is set so as to be higher than 0 (charging) when the SOC has decreased, whereas Pchg is set so as to be lower than 0 (discharging) when the SOC has increased.

In each of the CD mode and the CS mode, start-up and stop of the engine 100 are controlled on the basis of a comparison between the output parameter Pr and the threshold Pth. Specifically, during stop of the engine 100, the engine 100 is started up when Pr>Pth. On the other hand, during operation of the engine 100, the engine 100 is stopped when Pr<Pth. At the time of determination as to whether to stop the engine 100, a threshold may be set to have hysteresis for the threshold Pth that is used in start-up determination.

Thus, the engine 100 is intermittently operated in correspondence with high output of the hybrid vehicle 1 where the output parameter Pr is higher than the threshold Pth (engine start-up threshold).

As shown in FIG. 5, Pth is set to P1 in the CD mode, while Pth is set to P2 (P2<P1) in the CS mode. Thus, in the CD mode, the frequency of traveling in the EV mode is increased by suppressing the frequency of operation of the engine 100, so it is possible to actively use energy stored in the electrical storage device B without keeping the SOC. On the other hand, in the CS mode, the frequency of operation of the engine 100 becomes higher than that in the CD mode, so it is easy to keep the SOC.

The output parameter Pr for controlling whether to operate or stop the engine 100 may be other than the total required power Ptl. For example, a required torque or required acceleration that is calculated so as to reflect at least an accelerator pedal operation amount, or an accelerator pedal operation amount itself may be used as the output parameter Pr. In these cases as well, the threshold Pth that is compared with the output parameter Pr is set to a higher value in the CD mode than that in the CS mode as described above. In this way, with whether there is engine start-up for charging the electrical storage device B and the engine start-up threshold, the frequency of start-up of the engine 100 in an engine start-up condition in the CS mode is set so as to be higher than the frequency of start-up of the engine 100 in the engine start-up condition in the CD mode.

Next, the configuration of the engine 100 and control over each intake valve of the engine 100 will be described in detail.

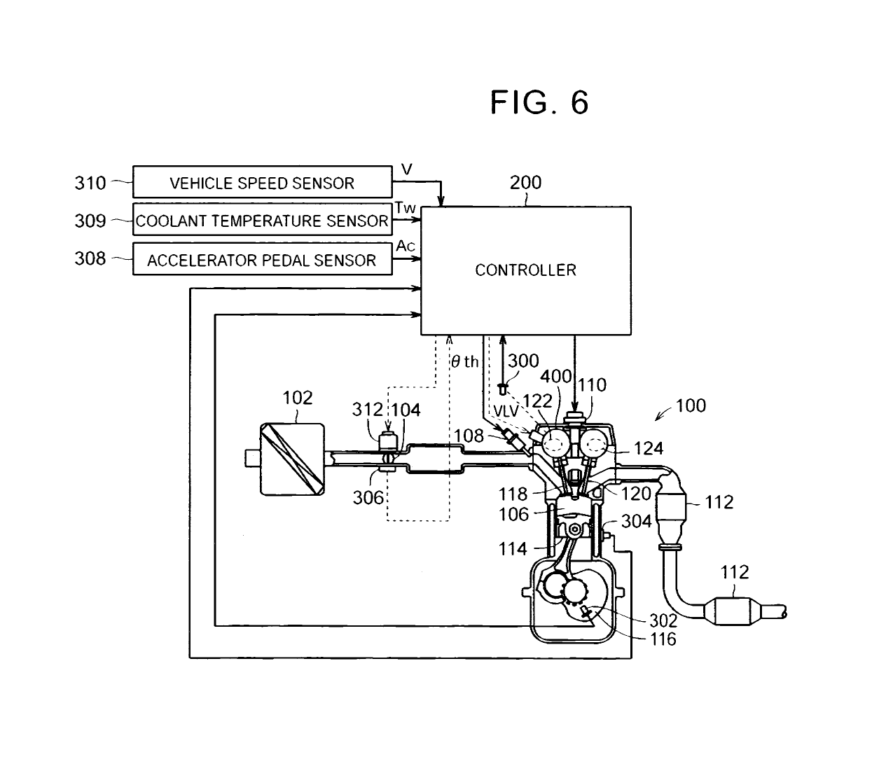

FIG. 6 is a view that shows the configuration of the engine 100 shown in FIG. 1. As shown in FIG. 6, air is taken into the engine 100 through an air cleaner 102. An intake air amount is adjusted by a throttle valve 104. The throttle valve 104 is an electrically controlled throttle valve that is driven by a throttle motor 312.

Each injector 108 injects fuel toward a corresponding intake port. Fuel is mixed with air in the intake port. Air-fuel mixture is introduced into each cylinder 106 when a corresponding intake valve 118 opens.

Each injector 108 may be provided as a direct injection injector that directly injects fuel into the corresponding cylinder 106. Alternatively, both the intake port injection injector 108 and the direct injection injector 108 may be provided.

Air-fuel mixture in each cylinder 106 is ignited by a corresponding ignition plug 110 to combust. The combusted air-fuel mixture, that is, exhaust gas, is purified by a three-way catalyst 112, and is then emitted to the outside of the vehicle. A piston 114 is pushed downward by combustion of air-fuel mixture, and a crankshaft 116 rotates.

The intake valve 118 and an exhaust valve 120 are provided at the top portion of each cylinder 106. The amount of air that is introduced into each cylinder 106 and the timing of introduction are controlled by the corresponding intake valve 118. The amount of exhaust gas that is emitted from each cylinder 106 and the timing of emission are controlled by the corresponding exhaust valve 120. Each intake valve 118 is driven by a cam 122. Each exhaust valve 120 is driven by a cam 124.

As will be described in detail later, the valve lift and valve operating angle of each intake valve 118 are controlled by a variable valve lift (VVL) device 400. The valve lift and valve operating angle of each exhaust valve 120 may also be controlled. A variable valve timing (VVT) device that controls the open/close timing may be combined with the VVL device 400.

The controller 200 controls a throttle opening degree 0th, an ignition timing, a fuel injection timing, a fuel injection amount, and the operating state (open/close timing, valve lift, valve operating angle, and the like) of each intake valve so that the engine 100 is placed in a desired operating state. Signals are input to the controller 200 from various sensors, that is, a cam angle sensor 300, a crank angle sensor 302, a knock sensor 304, a throttle opening degree sensor 306, an accelerator pedal sensor 308, a coolant temperature sensor 309 and a vehicle speed sensor 310.

The cam angle sensor 300 outputs a signal indicating a cam position. The crank angle sensor 302 outputs signals indicating the rotation speed of the crankshaft 116 (engine rotation speed) and the rotation angle of the crankshaft 116. The knock sensor 304 outputs a signal indicating the strength of vibrations of the engine 100. The throttle opening degree sensor 306 outputs a signal indicating the throttle opening degree θth. The coolant temperature sensor 309 detects a coolant temperature Tw of the engine 100. The vehicle speed sensor 310 detects a vehicle speed V of the hybrid vehicle 1. The detected coolant temperature Tw and the detected vehicle speed V are input to the controller 200. The accelerator pedal sensor 308 detects a driver's operation amount of an accelerator pedal (not shown), and outputs a signal Ac to the controller 200. The signal Ac indicates the detected operation amount. The controller 200 is able to calculate a driver's required acceleration on the basis of the signal Ac received from the accelerator pedal sensor 308.

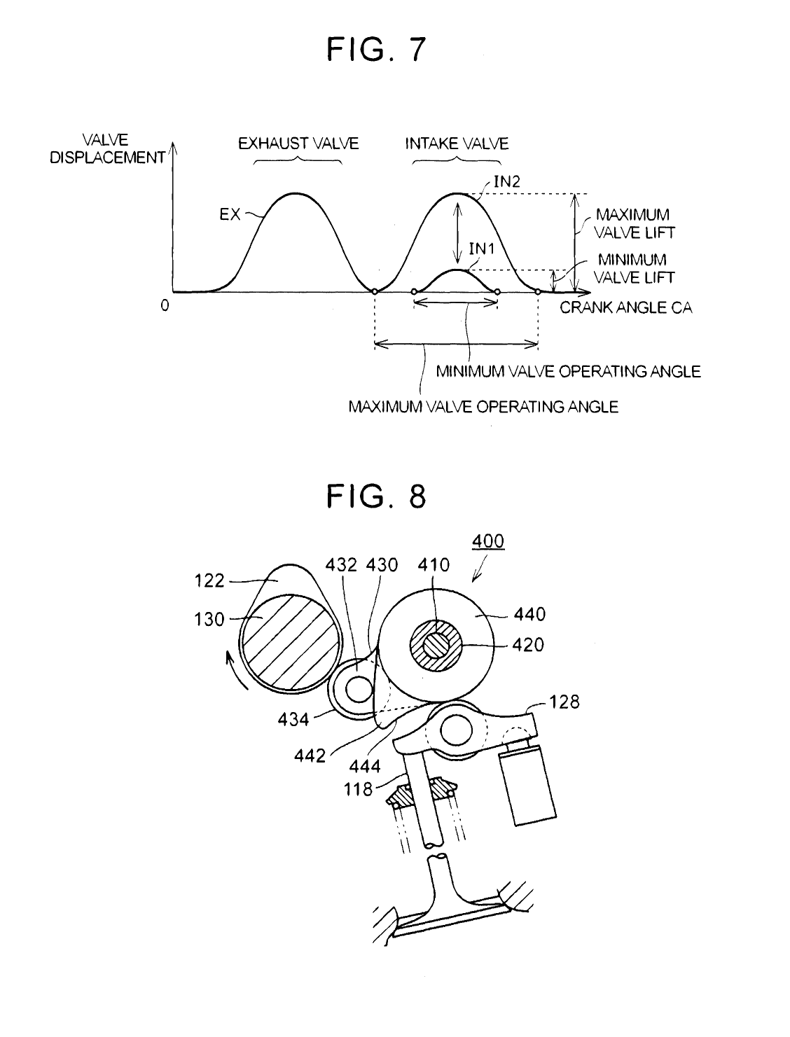

FIG. 7 is a graph that shows the correlation between a crank angle and a valve displacement that is achieved by the VVL device 400. As shown in FIG. 7, each exhaust valve 120 opens and closes in an exhaust stroke, and each intake valve 118 opens and closes in an intake stroke. The valve displacement of each exhaust valve 120 is indicated by a waveform EX. The valve displacement of each intake valve 118 is indicated by waveforms IN1, IN2.

The valve displacement is a displacement of each intake valve 118 from a state where the intake valve 118 is closed. The valve lift is a valve displacement at the time when the opening degree of each intake valve 118 has reached a peak. The valve operating angle is a crank angle of a period from when each intake valve 118 opens to when the intake valve 118 closes.

The operation characteristic of each intake valve 118 is changed by the VVL device 400 between the waveforms IN1, IN2. The waveform IN1 indicates the case where the valve lift and the valve operating angle are minimum. The waveform IN2 indicates the case where the valve lift and the valve operating angle are maximum. In the VVL device 400, the valve operating angle increases with an increase in the valve lift. That is, in the VVL device 400 illustrated in the present embodiment, the valve lift and the valve operating angle are changed as the operation characteristic of each intake valve 118.

FIG. 8 is a front view of the VVL device 400 that is one example of a device that controls the valve lift and valve operating angle of each intake valve 118.

As shown in FIG. 8, the VVL device 400 includes a drive shaft 410, a support pipe 420, an input arm 430, and oscillation cams 440. The drive shaft 410 extends in one direction. The support pipe 420 covers the outer periphery of the drive shaft 410. The input arm 430 and the oscillation cams 440 are arranged in the axial direction of the drive shaft 410 on the outer periphery of the support pipe 420. An actuator (not shown) that linearly actuates the drive shaft 410 is connected to the distal end of the drive shaft 410.

The VVL device 400 includes the one input arm 430 in correspondence with the one cam 122 provided in each cylinder. The two oscillation cams 440 are provided on both sides of each input arm 430 in correspondence with the corresponding pair of intake valves 118 provided for each cylinder.

The support pipe 420 is formed in a hollow cylindrical shape, and is arranged parallel to a camshaft 130. The support pipe 420 is fixed to a cylinder head so as not to be moved in the axial direction or rotated.

The drive shaft 410 is inserted inside the support pipe 420 so as to be slidable in the axial direction. The input arm 430 and the two oscillation cams 440 are provided on the outer periphery of the support pipe 420 so as to be oscillatable about the axis of the drive shaft 410 and not to move in the axial direction.

The input arm 430 includes an arm portion 432 and a roller portion 434. The arm portion 432 protrudes in a direction away from the outer periphery of the support pipe 420. The roller portion 434 is rotatably connected to the distal end of the arm portion 432. The input arm 430 is provided such that the roller portion 434 is arranged at a position at which the roller portion 434 is able to contact the cam 122.

Each oscillation cam 440 has a substantially triangular nose portion 442 that protrudes in a direction away from the outer periphery of the support pipe 420. A concave cam face 444 is formed at one side of the nose portion 442. A roller rotatably attached to a rocker arm 128 is pressed against the cam face 444 by the urging force of a valve spring provided in the intake valve 118.

The input arm 430 and the oscillation cams 440 integrally oscillate about the axis of the drive shaft 410. Therefore, as the camshaft 130 rotates, the input arm 430 that is in contact with the cam 122 oscillates, and the oscillation cams 440 oscillate in interlocking with movement of the input arm 430. The movements of the oscillation cams 440 are transferred to the intake valves 118 via rocker arms 128, and the intake valves 118 are opened or closed.

The VVL device 400 further includes a device that changes a relative phase difference between the input arm 430 and each oscillation cam 440 around the axis of the support pipe 420. The valve lift and valve operating angle of each intake valve 118 are changed as needed by the device that changes the relative phase difference.

That is, when the relative phase difference between the input arm 430 and each oscillation cam 440 is increased, the oscillation angle of each rocker arm 128 is increased with respect to the oscillation angle of each of the input arm 430 and the oscillation cams 440, and the valve lift and valve operating angle of each intake valve 118 are increased.

When the relative phase difference between the input arm 430 and each oscillation cam 440 is reduced, the oscillation angle of each rocker arm 128 is reduced with respect to the oscillation angle of each of the input arm 430 and the oscillation cams 440, and the valve lift and valve operating angle of each intake valve 118 are reduced.

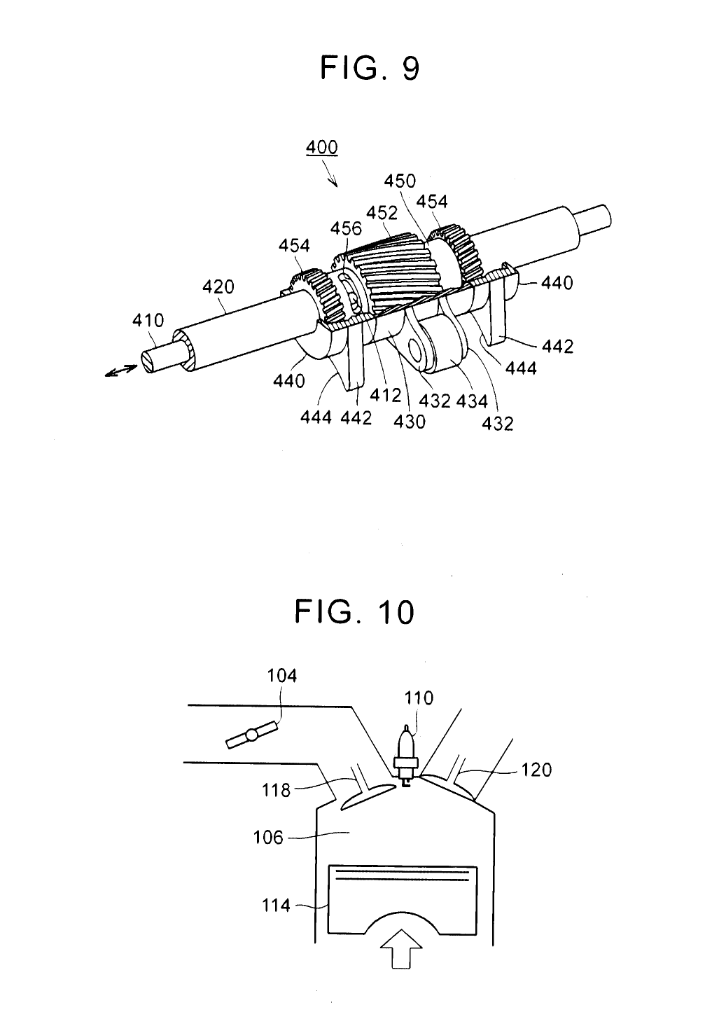

FIG. 9 is a perspective view that partially shows the VVL device 400. FIG. 9 shows a structure with part cut away so that the internal structure is clearly understood.

As shown in FIG. 9, a slider gear 450 is accommodated in a space defined between the outer periphery of the support pipe 420 and the set of input arm 430 and two oscillation cams 440. The slider gear 450 is supported on the support pipe 420 so as to be rotatable and slidable in the axial direction. The slider gear 450 is provided on the support pipe 420 so as to be slidable in the axial direction.

The slider gear 450 includes a helical gear 452. The helical gear 452 is located at the center portion of the slider gear 450 in the axial direction. Right-handed screw spiral helical splines are formed on the helical gear 452. The slider gear 450 includes helical gears 454. The helical gears 454 are respectively located on both sides of the helical gear 452. Left-handed screw spiral helical splines opposite to those of the helical gear 452 are formed on each of the helical gears 454.

On the other hand, helical splines corresponding to the helical gears 452, 454 are respectively formed on the inner peripheries of the input arm 430 and two oscillation cams 440. The inner peripheries of the input arm 430 and two oscillation cams 440 define a space in which the slider gear 450 is accommodated. That is, the right-handed spiral helical splines are formed on the input arm 430, and the helical splines are in mesh with the helical gear 452. The left-handed spiral helical splines are formed on each of the oscillation cams 440, and the helical splines are in mesh with the corresponding helical gear 454.

An oblong hole 456 is formed in the slider gear 450. The oblong hole 456 is located between the helical gear 452 and one of the helical gears 454, and extends in the circumferential direction. Although not shown in the drawing, an oblong hole is formed in the support pipe 420, and the oblong hole extends in the axial direction so as to partially overlap with the oblong hole 456. A locking pin 412 is integrally provided in the drive shaft 410 inserted inside the support pipe 420. The locking pin 412 protrudes through the overlapped portions of these oblong hole 456 and oblong hole (not shown).

When the drive shaft 410 is moved in the axial direction by the actuator (not shown) coupled to the drive shaft 410, the slider gear 450 is pressed by the locking pin 412, and the helical gears 452, 454 move in the axial direction of the drive shaft 410 at the same time. When the helical gears 452, 454 are moved in this way, the input arm 430 and the oscillation cams 440 spline-engaged with these helical gears 452, 454 do not move in the axial direction. Therefore, the input arm 430 and the oscillation cams 440 pivot around the axis of the drive shaft 410 through meshing of the helical splines.

At this time, the helical splines respectively formed on the input arm 430 and each oscillation cam 440 have opposite orientations. Therefore, the pivot direction of the input arm 430 and the pivot direction of each oscillation cam 440 are opposite to each other. Thus, the relative phase difference between the input arm 430 and each oscillation cam 440 changes, with the result that the valve lift and valve operating angle of each intake valve 118 are changed as is already described.

The controller 200 controls the valve lift and valve operating angle of each intake valve 118 by adjusting an operation amount of the actuator that linearly moves the drive shaft 410. The actuator may be, for example, formed of an electric motor. In this case, the electric motor that constitutes the actuator generally receives electric power supplied from a battery (auxiliary battery) other than the electrical storage device B. Alternatively, the actuator may be configured to operate by hydraulic pressure. The hydraulic pressure is generated from an oil pump that is driven by the engine 100.

The VVL device is not limited to the type illustrated in FIG. 8 and FIG. 9. For example, a VVL device that electrically drives each valve, a VVL device that hydraulically drives each valve, or the like, may be used. That is, in the present embodiment, the mechanism of changing the operation characteristic of each intake valve 118 is not specifically limited. A known mechanism may be employed as needed.

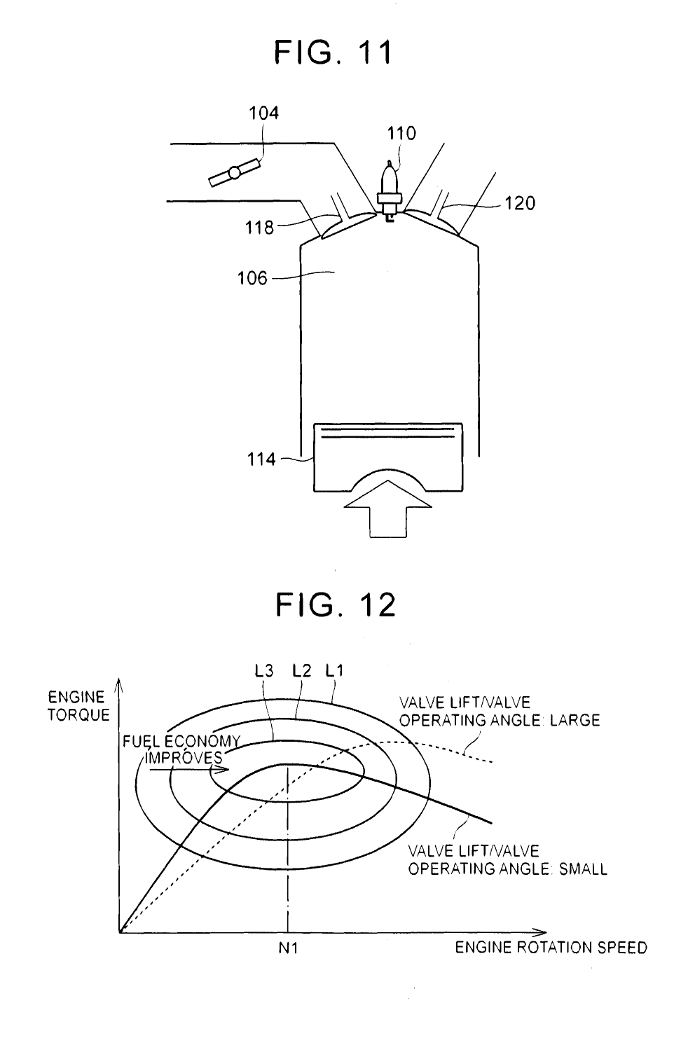

FIG. 10 is a view that illustrates an operation at the time when the valve lift and valve operating angle of each intake valve 118 are large. FIG. 11 is a view that illustrates an operation at the time when the valve lift and valve operating angle of each intake valve 118 are small.

As shown in FIG. 10 and FIG. 11, when the valve lift and valve operating angle of each intake valve 118 are large, because the close timing of each intake valve 118 delays, the engine 100 runs on the Atkinson cycle. That is, part of air taken into the cylinder 106 in the intake stroke is returned to the outside of the cylinder 106, so compression reaction that is a force for compressing air decreases in the compression stroke. Thus, it is possible to reduce vibrations at engine start-up. Because the compression ratio decreases, ignitability deteriorates, and the output response of the engine 100 decreases.

On the other hand, when the valve lift and valve operating angle of each intake valve 118 are small, because the close timing of each intake valve 118 advances, the compression ratio increases. Thus, ignitability improves at a low temperature, and the output response of the engine improves. Because the compression reaction increase, vibrations at engine start-up can increase.

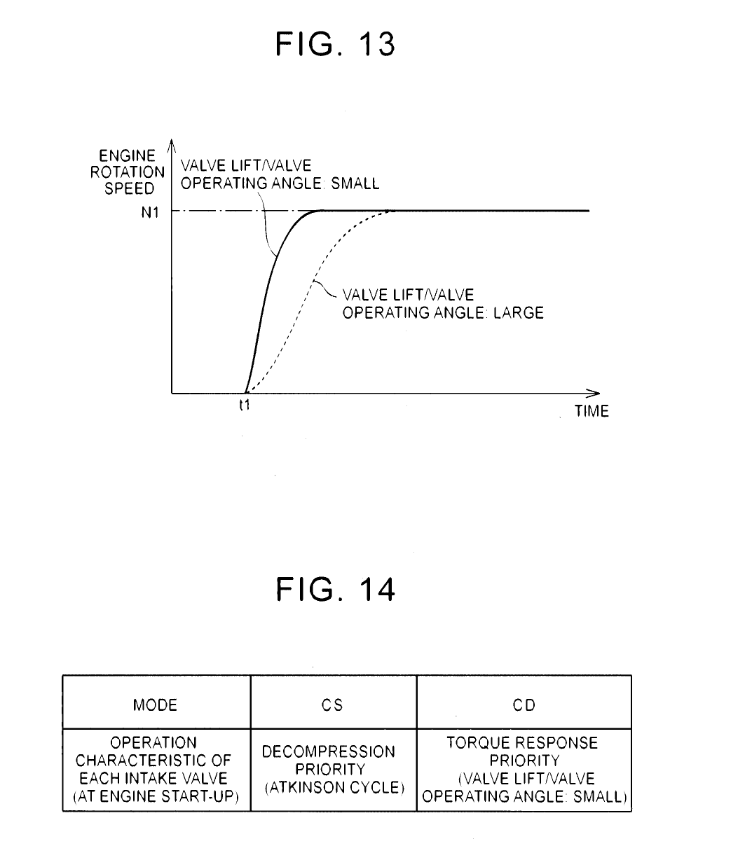

FIG. 12 and FIG. 13 are graphs for illustrating a change in the output response of the engine 100 at the time when the operation characteristic of each intake valve 118 is changed. FIG. 12 shows the correlation between an engine rotation speed and an engine torque. FIG. 13 shows a temporal change in the engine rotation speed after engine start-up is started at time t1. FIG. 12 and FIG. 13 show the characteristics at the time when both the valve lift and valve operating angle of each intake valve 118 are changed (increased or reduced) by the VVL device 400. However, a qualitatively equivalent characteristic appears at the time when one of the valve lift and the valve operation angle is changed (increased or reduced) as well.

In FIG. 12 and FIG. 13, the continuous line indicates the case where the valve lift and operating angle of each intake valve 118 are small (for example, minimum setting), and the dashed line indicates the case where the valve lift and valve operating angle of each intake valve 118 are large (for example, maximum setting).

FIG. 12 is a time chart that illustrates a difference in the response of engine torque due to the characteristic of each intake valve 118. In FIG. 12, the abscissa axis represents time, and the ordinate axis represents engine rotation speed. FIG. 13 is a graph that illustrates a difference in engine torque due to the characteristic of each intake valve 118. In FIG. 13, the abscissa axis represents engine rotation speed, and the ordinate axis represents engine torque. In FIG. 12 and FIG. 13, the continuous line indicates the case where the valve lift and the valve operating angle are small, and the dashed line indicates the case where the valve lift and the valve operating angle are large.

As shown in FIG. 12, in the range in which the engine rotation speed is low, the engine torque in the case where the valve lift and valve operating angle of each intake valve 118 are small is larger than the engine torque in the case where the valve lift and the valve operating angle are large. This is because part of air taken into the cylinder is returned to the outside of the cylinder when the valve lift and the valve operating angle are large, whereas the compression ratio increases because each intake valve 118 is closed early when the valve lift and the valve operating angle are small.

In the region in which the engine rotation speed is high, the engine torque in the case where the valve lift and valve operating angle of each intake valve 118 are large is larger than the engine torque in the case where the valve lift and the valve operating angle are small. This is because, in the region in which the engine rotation speed is high, a large amount of air is introduced into the cylinder by the inertial force of air even when the close timing of each intake valve 118 is delayed.

Each of lines L1 to L3 shown in FIG. 12 indicates an equal fuel consumption line, and fuel economy is higher in order of the lines L1 to L3. Thus, the operating point of the engine 100 during operation of the engine 100 is set in a high fuel economy region. Even at engine start-up, the engine operating point is desirably set to a high fuel economy point that falls within a relatively low rotation speed region. For example, the engine rotation speed is set to a predetermined value N1 in the graph as a target operating point at engine start-up.

As shown in FIG. 13, at engine start-up, as the valve lift and valve operating angle of each intake valve 118 are reduced, the rate of increase in engine rotation speed increases. As a result, it is possible to quickly increase the engine rotation speed to the engine rotation speed (predetermined value N1) at the target operating point at engine start-up shown in FIG. 12. This is because, as is understood from FIG. 12, as the valve lift and valve operating angle of each intake valve 118 are reduced, it is possible to increase engine torque in a low rotation speed region.

Referring back to FIG. 5, in the hybrid vehicle 1, the engine 100 is started up at the time when the output parameter Pr exceeds the threshold Pth (engine start-up threshold), with the result that the engine 100 is intermittently operated in correspondence with high output of the engine 100. The engine start-up threshold Pth is set such that the engine start-up threshold Pth in the CD mode is higher than that in the CS mode.

Thus, in the CS mode, the frequency of start-up of the engine 100 increases as compared to the CD mode. At the time when the engine 100 is started up in the CD mode, a higher output tends to be required of the engine 100 as compared to that at the time when the engine 100 is started up in the CS mode.

Therefore, in the first embodiment, the operation characteristic of each intake valve 118 at engine start-up is appropriately controlled in correspondence with a selected one of the CS mode and the CD mode.

As shown in FIG. 14, in the first embodiment, when the CS mode in which the frequency of start-up of the engine 100 is high is selected, the operation characteristic of each intake valve 118 at start-up of the engine 100 is controlled by giving a higher priority to vibration suppression at engine start-up.

In contrast, when the CD mode in which the frequency of start-up of the engine is relatively low is selected, the operation characteristic of each intake valve 118 is controlled such that the valve lift and valve operating angle of each intake valve 118 at engine start-up are smaller than the valve lift and valve operating angle of each intake valve 118 in the CS mode. That is, the operation characteristic of each intake valve 118 is controlled by giving a higher priority to the output response (torque response) of the engine 100. Thus, when the engine 100 is started up with reference to the engine start-up threshold Pth higher than that in the CS mode as well, it is possible to quickly ensure the output of the engine 100.

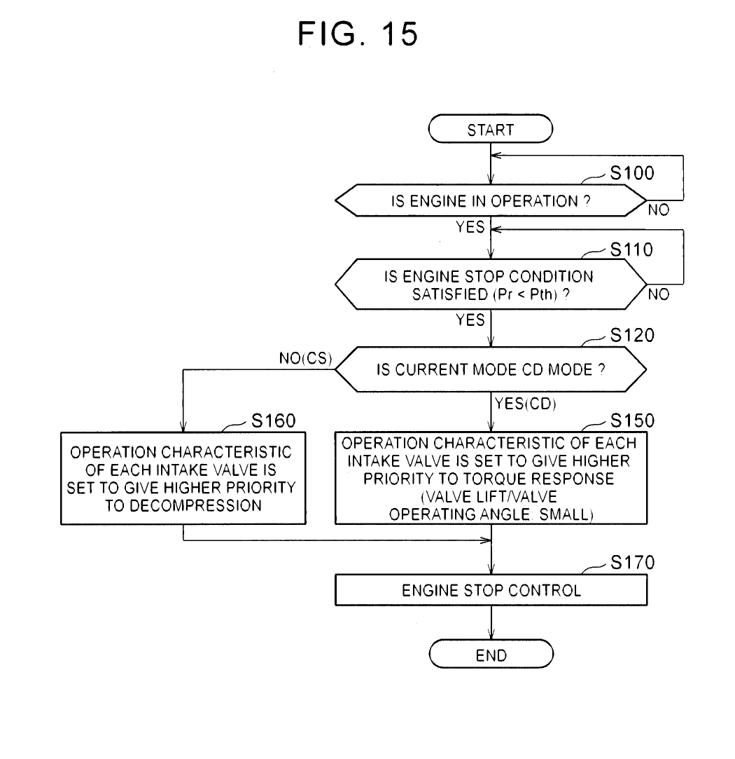

FIG. 15 is a flowchart that illustrates the control structure of intake valve control in the hybrid vehicle according to the first embodiment. The control process shown in FIG. 15 may be executed by the controller 200.

As shown in FIG. 15, the controller 200 executes the processes from step S110 during engine operation, that is, when affirmative determination is made in step S100. During engine operation (when affirmative determination is made in S100), the controller 200 determines whether the engine stop condition is satisfied (S110). For example, as described with reference to FIG. 5, when the output parameter Pr (total required power Ptl) becomes lower than the predetermined threshold, the engine stop condition is satisfied, with the result that the engine stop command is issued. Thus, an engine stop process is started. When the engine stop condition is not satisfied (when negative determination is made in S110), no engine stop command is issued, and the operated state of the engine 100 is continued.

When the engine stop command is issued (when affirmative determination is made in S110), the controller 200 determines whether the current mode is the CD mode (S120). When the CD mode is selected (when affirmative determination is made in S120), the controller 200 sets the operation characteristic of each intake valve 118 by giving a higher priority to torque response (S150) as described in FIG. 12 to FIG. 14. On the other hand, when the CS mode is selected (when negative determination is made in S120), the controller 200 sets the operation characteristic of each intake valve 118 by giving a higher priority to decompression in order to suppress vibrations at engine start-up (S160). That is, the valve lift and valve operating angle of each intake valve 118 in the operation characteristic of each intake valve 118, set in step S150, are smaller than the valve lift and valve operating angle of each intake valve 118 in the operation characteristic of each intake valve 118, set in step S160.

The controller 200 executes control for stopping the engine 100 (S170). Thus, fuel injection from each injector 108 is stopped, and the torque of the motor generator MG1 is controlled so as to smoothly stop the engine 100. During engine stop control (S170), the controller 200 controls the VVL device 400 such that the operation characteristic of each intake valve 118, set in step S150 or step S160, is achieved.

Thus, during the stop process of the engine 100 based on the engine stop command, it is possible to appropriately set the operation characteristic of each intake valve 118 in preparation for the next engine start-up in correspondence with the mode (CD/CS) of the hybrid vehicle 1. Specifically, it is possible to give a higher priority to vibration suppression at engine start-up when the CS mode in which the frequency of engine start-up is relatively high is selected, and change the operation characteristic of each intake valve 118 so as to give a higher priority to torque response at engine start-up when the CD mode is selected. Thus, when the CD mode is selected, it is possible to quickly ensure the output of the engine 100 even when a higher output as compared to that in the CS mode is required at engine start-up.

Thus, with the hybrid vehicle according to the first embodiment, it is possible to control the operation characteristic of each intake valve 118 at start-up of the engine 100 so that vibration suppression and output characteristic (torque response) at engine start-up are ensured on the basis of the driving mode (CD mode or CS mode).

In the first embodiment (FIG. 15), the operation characteristic of each intake valve 118 at the next engine start-up is controlled in accordance with the mode at the time of the engine stop process. Thus, when the mode is changed in the period from engine stop to the next engine start-up, there is a possibility that it is not possible to appropriately control the operation characteristic of each intake valve 118 at engine start-up.

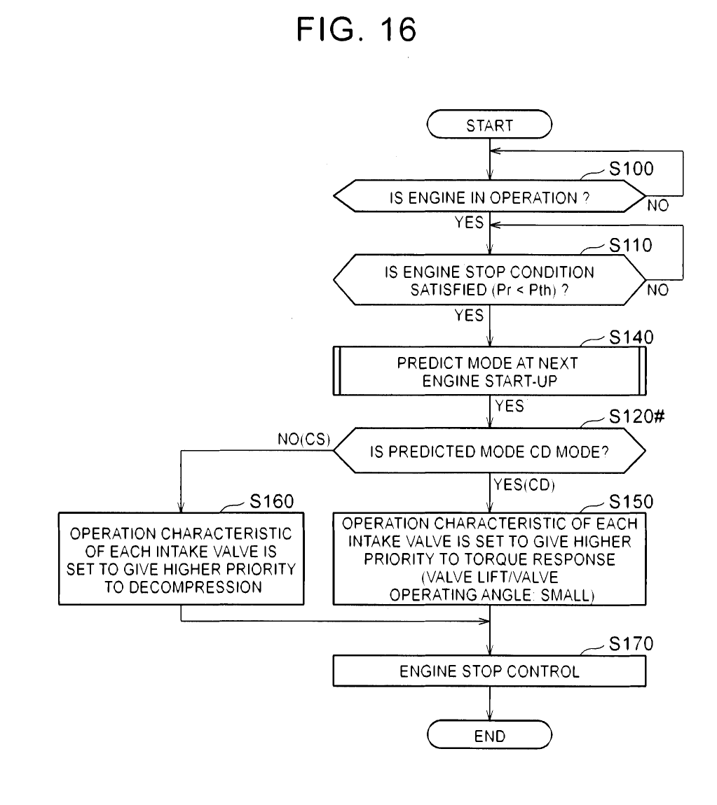

FIG. 16 is a flowchart that illustrates the control structure of intake valve control in the hybrid vehicle according to an alternative embodiment to the first embodiment. The control process shown in FIG. 16 may be executed by the controller 200.

By comparing FIG. 16 with FIG. 15, in the engine stop process in the hybrid vehicle according to the alternative embodiment to the first embodiment, after step S100 and step S110 similar to those of FIG. 15 are executed, when the engine stop command is issued as a result of the fact that the engine stop condition is satisfied (when negative determination is made in S110), the controller 200 predicts the mode at the next engine start-up in step S140.

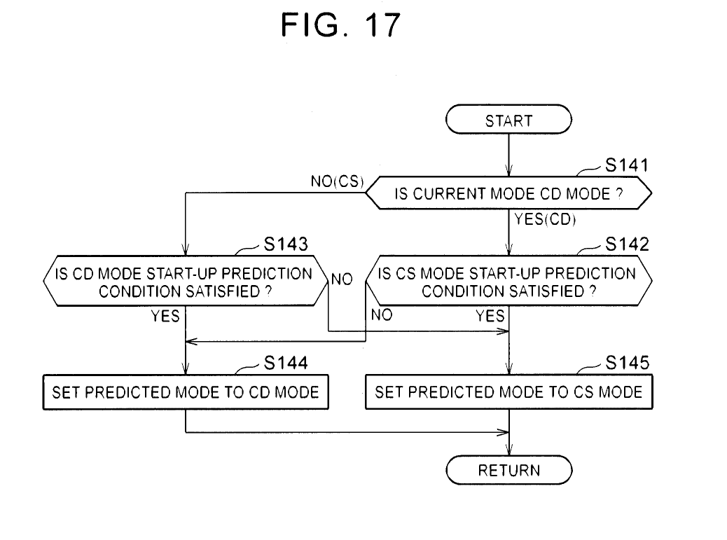

FIG. 17 is a flowchart that illustrates the control process for predicting the mode at the next engine start-up in step S140 shown in FIG. 16 in further details. As shown in FIG. 17, step S140 shown in FIG. 16 includes the following step S141 to step S145.

The controller 200 determines in step S141 whether the current mode, that is, the mode at the time of the engine stop process, is the CD mode. When the current mode is the CD mode (when affirmative determination is made in S141), the controller 200 determines in step S142 whether a CS mode start-up prediction condition is satisfied. The CS mode start-up prediction condition is satisfied when the CS mode is applied at the next engine start-up. The CS mode start-up prediction condition may be determined in advance by using a vehicle condition, such as the SOC of the electrical storage device B, travel information that is acquired by the car navigation system 350, and input operation to the operation switch 360.

For example, the CS mode start-up prediction condition is satisfied when the current mode is the CD mode although the CS mode is selected by the user with the operation switch 360. Alternatively, the CS mode start-up prediction condition is satisfied when the SOC of the electrical storage device B has decreased to near the determination value Sth shown in FIG. 2. For example, when a predicted time until SOC becomes lower than Sth is shorter than a predetermined time on the basis of the rate of decrease in the current SOC, it may be determined that the CS mode start-up prediction condition is satisfied.

When the hybrid vehicle 1 is traveling in an area in which the user drives the vehicle by actively selecting the CS mode through operation of the operation switch 360 in view of a past travel history on the basis of the travel information from the car navigation system 350, it may be determined that the CS mode start-up prediction condition is satisfied.

In this way, even when the current mode is the CD mode but when the predetermined CS mode start-up prediction condition is satisfied (when affirmative determination is made in S142), the controller 200 proceeds with the process to step S145, and specifies the predicted mode at the next engine start-up to the CS mode.

On the other hand, when the current mode is the CD mode and the CS mode start-up prediction condition is not satisfied (when negative determination is made in S142), the controller 200 proceeds with the process to step S144, and sets the predicted mode to the CD mode in accordance with the current mode.

Conversely, when the current mode is the CS mode (when negative determination is made in S141), the controller 200 proceeds with the process to step S143, and determines whether a CD mode start-up prediction condition is satisfied. The CD mode start-up prediction condition is satisfied when the CD mode is applied at the next engine start-up.

The CD mode start-up prediction condition, as well as the CS mode start-up prediction condition, may be determined in advance by using the vehicle condition of the hybrid vehicle 1.

For example, the CD mode start-up prediction condition is satisfied when such long downhill traveling that the SOC exceeds the determination value Sth# (FIG. 4) as a result of regenerative power generation is predicted before the next engine start-up on the basis of the travel information from the car navigation system 350. Alternatively, it may be determined that the CD mode start-up prediction condition is satisfied when the hybrid vehicle 1 is approaching an area in which the user drives the vehicle by actively selecting the CD mode (for example, an area within a set distance from home) on the basis of the past travel history stored in the car navigation system 350.

Even when the current mode is the CS mode but when the predetermined CD mode start-up prediction condition is satisfied (when affirmative determination is made in S143), the controller 200 proceeds with the process to step S144, and specifies the predicted mode at the next engine start-up to the CD mode.

On the other hand, when the current mode is the CS mode and the CD mode start-up prediction condition is not satisfied (when negative determination is made in S143), the controller 200 proceeds with the process to step S145, and sets the predicted mode to the CS mode in accordance with the current mode.

In this way, through the process of step S140 (FIG. 16), it is possible to predict whether the mode of the hybrid vehicle 1 at the next engine start-up is the CS mode or the CD mode on the basis of the mode and the vehicle condition at the time of the engine stop process.

Referring back to FIG. 16, subsequent to step S140, the controller 200 determines in step S120# whether the predicted mode at the next engine start-up is the CD mode.

The controller 200 proceeds with the process to step S150 as in the case of FIG. 15 when the predicted mode is the CD mode (when affirmative determination is made in S120#), and proceeds with the process to step S160 as in the case of FIG. 15 when the predicted mode is the CS mode (when negative determination is made in S120#). The controller 200 executes control for stopping the engine 100 (S170). During engine stop control (S170), the controller 200 controls the VVL device 400 such that the operation characteristic of each intake valve 118, set in step S150 or step S160, is achieved.

In this way, according to the alternative embodiment to the first embodiment, in the vehicle condition based on which the mode is predicted to change before the next engine start-up at the time of engine stop process, it is possible to set the operation characteristic of each intake valve 118 at start-up of the engine 100 to the operation characteristic suitable for the changed mode. As a result, it is possible to appropriately control the operation characteristic of each intake valve 118 at start-up of the engine 100 in correspondence with a change in the mode in the period until the next engine start-up.

Generally, a period during which the VVL device 400 is able to change the operation characteristic of each intake valve 118 depends on the actuator. For example, in the case of an actuator that uses hydraulic pressure from an engine-driven oil pump as power, it is difficult to change the operation characteristic of each intake valve 118 during the engine start-up process. In the case of an actuator formed of an electric motor, in order to make it possible to change the operation characteristic of each intake valve 118 during the engine start-up process, the output of large torque from the actuator is required as compared to the case where the operation characteristic of each intake valve 118 is changed during rotation of the engine.

In other words, with the control structure that changes the operation characteristic of each intake valve 118 by the VVL device 400 at the time of the engine stop process, illustrated in the first embodiment and the alternative embodiment to the first embodiment, the applicable mode of the VVL device 400 is wide.

On the other hand, even with the first embodiment and the alternative embodiment to the first embodiment, if the period from engine stop to engine start-up extends, the mode changes beyond prediction at the time of the engine stop process, with the result that there is a possibility that the operation characteristic of each intake valve 118 at start-up of the engine 100 is not the appropriate one that matches with the mode of the hybrid vehicle 1.

Thus, in a second embodiment, a control example in which the operation characteristic of each intake valve 118 is set at the time of engine start-up process will be described. The second embodiment may be applied to a hybrid vehicle including the VVL device 400 having a mechanism (actuator) that is able to change the operation characteristic of each intake valve 118 during stop of the engine 100 or at a low rotation speed of the engine 100, as described above.

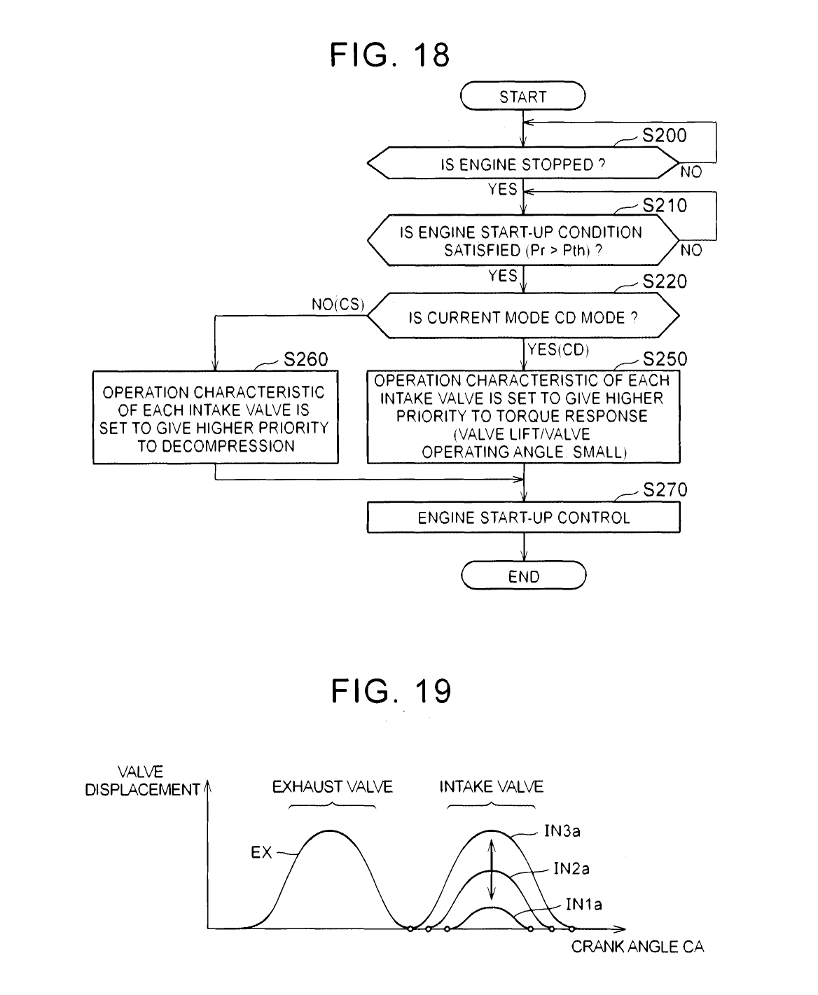

FIG. 18 is a flowchart that illustrates the control structure of intake valve control in the hybrid vehicle according to the second embodiment. The control process shown in FIG. 18 may be executed by the controller 200.

As shown in FIG. 18, the controller 200 executes the processes from step S210 during engine stop, that is, when affirmative determination is made in step S200. During engine stop (when affirmative determination is made in S200), the controller 200 determines whether the engine start-up condition is satisfied (S210). For example, as described with reference to FIG. 5, when the output parameter Pr (total required power Ptl) increases above the predetermined threshold, the engine start-up command is issued in response to the fact that the engine start-up condition is satisfied. When the engine start-up condition is not satisfied (when negative determination is made in S210), no engine start-up command is issued, and the stopped state of the engine 100 is continued.

When the engine start-up command is issued (when affirmative determination is made in S210), the controller 200 determines whether the current mode is the CD mode (S220). When the CD mode is selected (when affirmative determination is made in S220), the controller 200 sets the operation characteristic of each intake valve 118 by giving a higher priority to torque response (S250) as described with reference to FIG. 12 to FIG. 14. On the other hand, when the CS mode is selected (when negative determination is made in S220), the controller 200 sets the operation characteristic of each intake valve 118 by giving a higher priority to decompression (S260) in order to suppress vibrations at engine start-up. That is, the valve lift and valve operating angle of each intake valve 118 in the operation characteristic of each intake valve 118, which is set in step S250, are set so as to be smaller than the valve lift and valve operating angle of each intake valve 118 in the operation characteristic of each intake valve 118, which is set in step S260.

The controller 200 executes control for starting up the engine 100 (S270). Thus, in a state where the engine 100 is rotationally driven by cranking torque generated by the motor generator MG1, fuel injection from each injector 108 and ignition of each ignition plug 110 are started. During engine start-up control (S270), the controller 200 controls the VVL device 400 such that the operation characteristic of each intake valve 118, set in step S250 or step S260, is achieved. Setting of the operation characteristic of each intake valve 118 with the VVL device 400 at the time of the engine start-up process needs to complete before the initial ignition timing (so-called initial combustion timing) of the engine 100.

Thus, at start-up of the engine 100 (when the engine start-up condition is satisfied), it is possible to appropriately set the operation characteristic of each intake valve 118 in correspondence with the mode (driving mode) of the hybrid vehicle 1 as in the case of the first embodiment. Particularly, it is possible to set the operation characteristic of each intake valve 118 in correspondence with the mode at engine start-up. Therefore, when the period from engine stop to engine start-up extends as well, it is possible to control the operation characteristic of each intake valve 118 at start-up of the engine 100.

In the above-described embodiments and the alternative embodiment to the above described embodiment, the valve lift and valve operating angle of each intake valve 118 may be changed continuously (steplessly) or may be changed discretely (stepwisely).

FIG. 19 is a graph that shows the correlation between a crank angle and a valve displacement that is achieved by a VVL device 400A that is able to change the operation characteristic of each intake valve 118 in three steps. The VVL device 400A is configured to be able to change the operation characteristic to any one of first to third characteristics. The first characteristic is indicated by a waveform IN1a. The second characteristic is indicated by a waveform IN2a. The valve lift and the valve operating angle in the second characteristic are larger than the valve lift and the valve operating angle in the first characteristic. The third characteristic is indicated by a waveform IN3a. The valve lift and the valve operating angle in the third characteristic are larger than the valve lift and the valve operating angle in the second characteristic. The VVL device 400A, as well as the VVL device 400, is also configured to change both the valve lift and the valve operating angle that correspond to the operation characteristic of each intake valve 118. That is, the VVL device 400A is configured to change the valve lift and valve operating angle of each intake valve 118 in three steps.

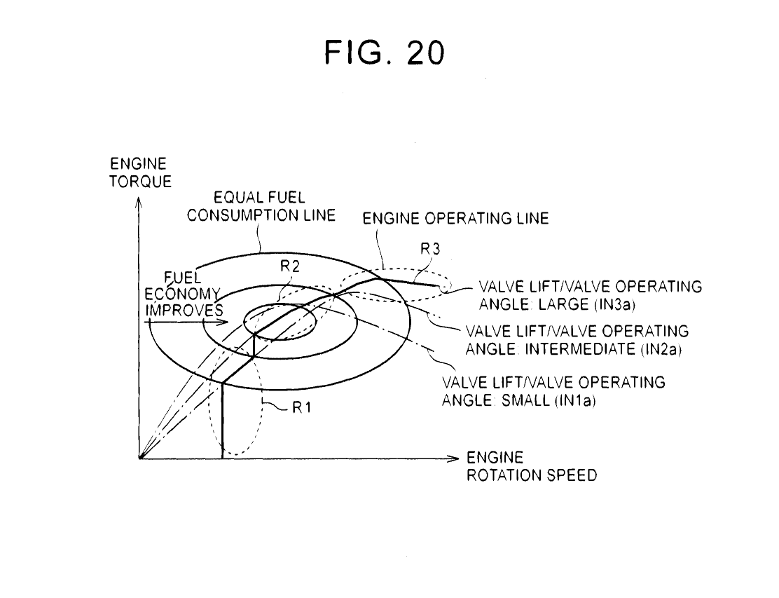

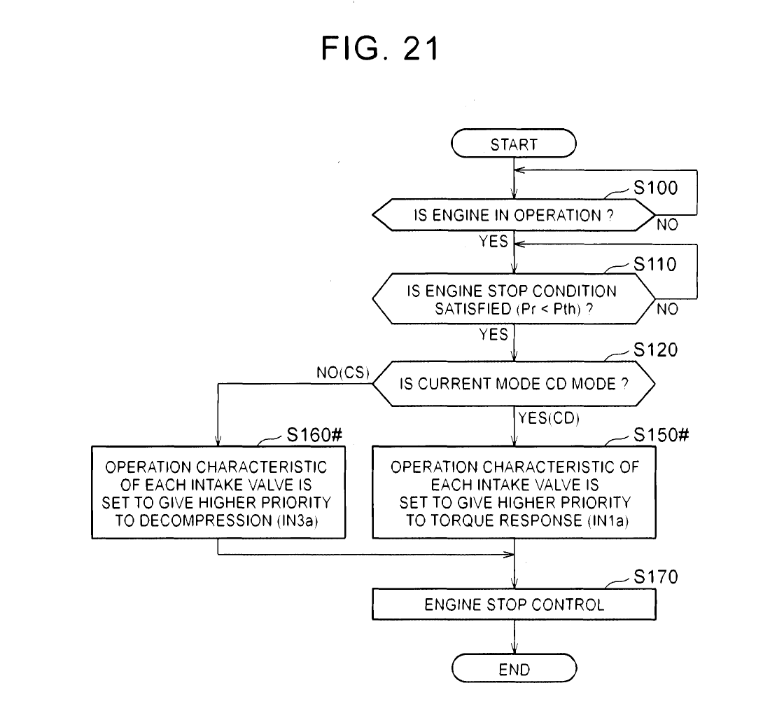

FIG. 20 is a graph that shows an operating line of an engine 100A including the VVL device 400A having the operation characteristics shown in FIG. 19.

In FIG. 20, the abscissa axis represents engine rotation speed, and the ordinate axis represents engine torque. The alternate long and short dashed lines in FIG. 20 indicate torque characteristics corresponding to the first to third characteristics (IN1a to IN3a). The circles indicated by the continuous line in FIG. 20 indicate equal fuel consumption lines. Each equal fuel consumption line is a line connecting points at which a fuel consumption amount is equal. The fuel economy improves as approaching the center of the circles. The engine 100A is basically operated along the engine operating line indicated by the continuous line in FIG. 20.

In a low rotation speed region indicated by the region R1, it is important to reduce shock at engine start-up. In addition, introduction of exhaust gas recirculation (EGR) gas is stopped, and fuel economy is improved by using the Atkinson cycle. The third characteristic (IN3a) is selected as the operation characteristic of each intake valve 118 so that the valve lift and valve operating angle increase. In an intermediate rotation speed region indicated by the region R2, fuel economy is improved by increasing the amount of introduction of EGR gas. Thus, the second characteristic (IN2a) is selected as the operation characteristic of each intake valve 118 so that the valve lift and the valve operating angle are intermediate.

That is, when the valve lift and valve operating angle of each intake valve 118 are large (third characteristic), improvement in fuel economy by using the Atkinson cycle is given a higher priority than improvement in fuel economy by introduction of EGR gas. On the other hand, when the intermediate valve lift and valve operating angle are selected (second characteristic), improvement in fuel economy by introduction of EGR gas is given a higher priority than improvement in fuel economy by using the Atkinson cycle.

In a high rotation speed region indicated by the region R3, a large amount of air is introduced into each cylinder by the inertia of intake air, and the output performance is improved by increasing an actual compression ratio. The third characteristic (IN3a) is selected as the operation characteristic of each intake valve 118 so that the valve lift and valve operating angle increase.

When the engine 100A is operated at a high load in the low rotation speed region, when the engine 100A is started up at an extremely low temperature or when a catalyst is warmed up, the first characteristic (IN1a) is selected as the operation characteristic of each intake valve 118 so that the valve lift and the valve operating angle decrease. In this way, the valve lift and the valve operating angle are determined on the basis of the operating state of the engine 100A.

FIG. 21 to FIG. 23 show flowcharts that illustrate the control structures of intake valve control by applying the VVL device 400A having the operation characteristics shown in FIG. 19 according to the first embodiment, the alternative embodiment to the first embodiment and the second embodiment.

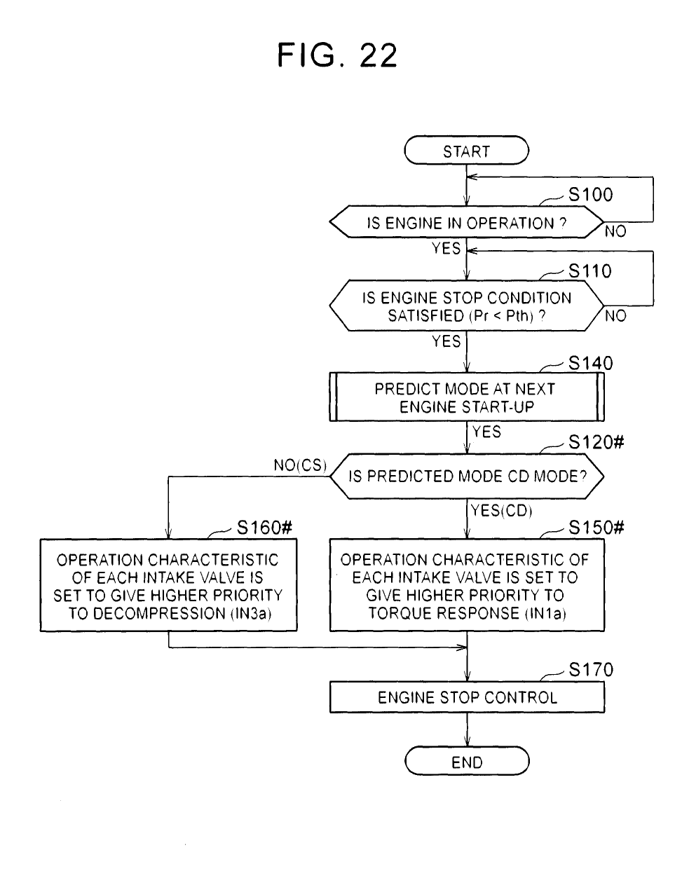

In each of FIG. 21 and FIG. 22, the VVL device 400A is controlled during the engine stop process such that the operation characteristic of each intake valve 118, set in step S150# or step S160# that is executed instead of step S150 or step S160, is achieved.

When the CS mode is selected, the controller 200 sets the operation characteristic of each intake valve 118 to the third characteristic (IN3a) in step S160#. Thus, vibrations at engine start-up are suppressed by applying the Atkinson cycle. On the other hand, when the CD mode is selected, the controller 200 sets the operation characteristic of each intake valve 118 to the first characteristic (IN1a) in step S150#. Thus, the output response (torque response) at engine start-up is increased, so it is possible to quickly ensure an output required of the engine 100.

The processes of step S100, step S110, step S120, step S120#, step S170 shown in FIG. 21 and FIG. 22 are similar to those of FIG. 15 and FIG. 16, so the description will not be repeated.

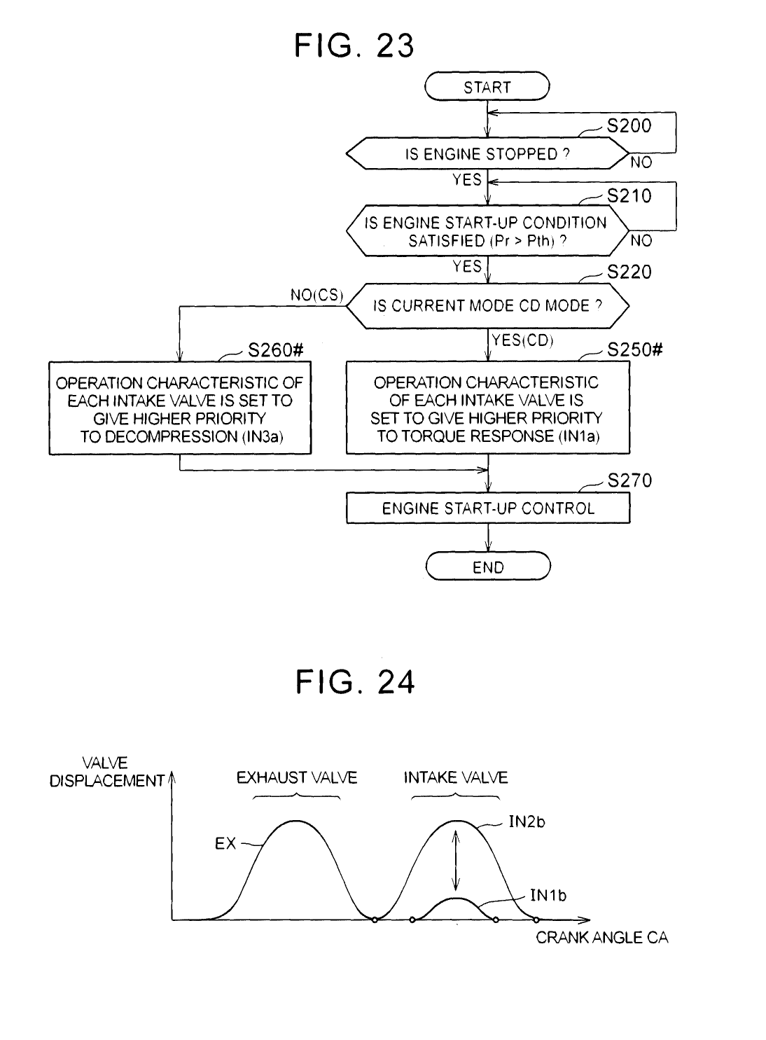

As shown in FIG. 23, the controller 200 controls the VVL device 400A during the engine stop process such that the operation characteristic of each intake valve 118, set in step S250# or step S260# instead of step S250 or step S260 (FIG. 18), is achieved.

When the CS mode is selected, the controller 200 sets the operation characteristic of each intake valve 118 to the third characteristic (IN3a) in step S260#, as well as step S160#. On the other hand, when the CD mode is selected, the controller 200 sets the operation characteristic of each intake valve 118 to the first characteristic (IN1a) in step S250#, as well step S150#.

In this way, when the VVL device 400A is applied as well, it is possible to execute intake valve controls according to the first embodiment, the alternative embodiment to the first embodiment and the second embodiment in accordance with the flowcharts shown in FIG. 21 to FIG. 23.

With the configuration in which the VVL device 400A is applied, because the operation characteristic, that is, the valve lift and valve operating angle, of each intake valve 118 is limited to three characteristics, it is possible to reduce a time that is required to adapt control parameters for controlling the operating state of the engine 100 in comparison with the case where the valve lift and valve operating angle of each intake valve 118 continuously change. In addition, it is possible to reduce torque that is required of the actuator for changing the valve lift and valve operating angle of each intake valve 118, so it is possible to reduce the size and weight of the actuator. Therefore, it is possible to reduce the manufacturing cost of the actuator.

FIG. 24 is a graph that shows the correlation between a crank angle and a valve displacement that is achieved by a VVL device 400B that is able to change the operation characteristic of each intake valve 118 in two steps. The VVL device 400B is configured to be able to change the operation characteristic to one of the first and second characteristics. The first characteristic is indicated by a waveform IN1b. The second characteristic is indicated by a waveform IN2b. The valve lift and the valve operating angle in the second characteristic are larger than the valve lift and the valve operating angle in the first characteristic. The VVL device 400B, as well as the VVL device 400, is also configured to change both the valve lift and the valve operating angle that correspond to the operation characteristic of each intake valve 118. That is, the VVL device 400B is configured to change the valve lift and valve operating angle of each intake valve 118 in two steps.

In this case, when the CS mode is selected, the operation characteristic of each intake valve 118 is set to the second characteristic (IN2a) (S160, S260), and, when the CD mode is selected, the operation characteristic of each intake valve 118 is set to the first characteristic (IN1a) (S150, S250). Thus, when the VVL device 400B is applied as well, it is possible to execute intake valve control according to the first embodiment, intake valve control according to the alternative embodiment to the first embodiment and intake valve control according to the second embodiment.

With the configuration in which the VVL device 400B is applied, because the operation characteristic, that is, the valve lift and valve operating angle, of each intake valve 118 is limited to two characteristics, it is possible to reduce a time that is required to adapt control parameters for controlling the operating state of the engine 100. In addition, it is possible to further simplify the configuration of the actuator. The operation characteristic, that is, the valve lift and valve operating angle, of each intake valve 118 is not limited to the case where the operation characteristic is changed in two steps or in three steps. The operation characteristic may be changed in any number of steps larger than or equal to four steps.

In the above-described embodiments and alternative embodiment, the valve operating angle is changed together with the valve lift in the operation characteristic of each intake valve 118. However, the disclosure is also applicable to an actuator that is able to change only the valve lift in the operation characteristic of each intake valve 118 or an actuator that is able to change only the valve operating angle in the operation characteristic of each intake valve 118. With the configuration that is able to change any one of the valve lift and valve operating angle of each intake valve 118 as well, it is possible to obtain similar advantageous effects to the case where it is possible to change both the valve lift and valve operating angle of each intake valve 118. The actuator that is able to change one of the valve lift and valve operating angle of each intake valve 118 may be implemented by utilizing a known technique. In this way, when a variable valve actuating mechanism that is able to continuously (steplessly) or discretely (stepwisely) change at least one of the valve lift and the valve operating angle as the operation characteristic of each intake valve 118 is employed in a hybrid vehicle, the disclosure is applicable.

In the above-described embodiments, the series-parallel hybrid vehicle that is able to transmit the power of the engine 100 by distributing the power of the engine 100 to the drive wheels 6 and the motor generators MG1, MG2 by the power split device 4. The disclosure is also applicable to a hybrid vehicle of another type. That is, the disclosure is also applicable to, for example, a so-called series hybrid vehicle in which the engine 100 is only used to drive the motor generator MG1 and the driving force of the vehicle is generated by only the motor generator MG2, a hybrid vehicle in which only regenerative energy within kinetic energy generated by the engine 100 is recovered as electric energy, a motor-assist hybrid vehicle in which the engine is used as a main power source and a motor, where necessary, assists, or the like. The disclosure is also applicable to a hybrid vehicle that travels by using the power of only the engine while the motor is separated.

In addition, in the present embodiments, an externally chargeable hybrid vehicle is illustrated as the hybrid vehicle of which the driving mode is changed between the CD mode and the CS mode; however, the configuration for external charging is not indispensable in application of the disclosure. For example, in a hybrid vehicle not having an external charging function by, for example, increasing the capacity of the electrical storage device as well, there is a possibility that it is possible to apply traveling in which the driving mode is changed between the CD mode and the CS mode.

In this way, the technical idea of the disclosure is applicable common to a hybrid vehicle that includes an internal combustion engine including a variable valve actuating device for changing the operation characteristic of each intake valve without specifically limiting the details of the vehicle configuration including a drive system or inclusion of an external charging function. The technical idea is that the operation characteristic (at least one of the valve lift and valve operating angle) of each intake valve at engine start-up is changed in correspondence with the mode (CD/CS).

In the above description, the engine 100 corresponds to one example of an “internal combustion engine” according to the disclosure, the motor generator MG2 corresponds to one example of a “rotary electric machine” according to the disclosure, and the motor generator MG1 corresponds to one example of a “power generating mechanism” according to the disclosure. The VVL devices 400, 400A, 400B correspond to one example of a “variable valve actuating device” according to the disclosure.

The embodiments described above should be regarded as only illustrative in every respect and not restrictive. The scope is defined by the appended claims rather than the description of the above embodiments. The scope is intended to encompass all modifications within the scope of the appended claims and equivalents thereof.

What is claimed is:

1. A hybrid vehicle comprising:
a rotary electric machine configured to generate driving force for the vehicle;
an internal combustion engine including a variable valve actuating device configured to change an operation characteristic of an intake valve; and
a controller configured to:
control travel of the vehicle by selectively applying one of a first driving mode and a second driving mode; and
control the variable valve actuating device such that at least one of a valve lift of the intake valve and a valve operating angle of the intake valve at start-up of the internal combustion engine when the first driving mode is selected is smaller than the corresponding at least one of the valve lift of the intake valve and the valve operating angle of the intake valve at start-up of the internal combustion engine when the second driving mode is selected, a start-up frequency of the internal combustion engine in a start-up condition in the second driving mode being higher than the start-up frequency of the internal combustion engine in the start-up condition in the first driving mode, the start-up condition being a condition for starting up the internal combustion engine in a stopped state, wherein
the internal combustion engine is intermittently operated in each of the first driving mode and the second driving mode, and wherein
the internal combustion engine is caused to operate based on an accelerator pedal operation amount.

2. The hybrid vehicle according to claim 1, wherein
the controller is configured to:
when the first driving mode is selected, start up the internal combustion engine when an output parameter of the vehicle exceeds a first threshold; and
when the second driving mode is selected, start up the internal combustion engine when the output parameter of the vehicle exceeds a second threshold, the second threshold is lower than the first threshold, the output parameter of the vehicle is calculated at least on the basis of the accelerator pedal operation amount.

3. The hybrid vehicle according to claim 1, wherein
the variable valve actuating device is configured to change the operation characteristic of the intake valve to one of a first characteristic and a second characteristic, and
the controller is configured to:
when the first driving mode is selected, control the variable valve actuating device such that the operation characteristic of the intake valve is set to the first characteristic at start-up of the internal combustion engine; and
when the second driving mode is selected, control the variable valve actuating device such that the operation characteristic of the intake valve is set to the second characteristic at start-up of the internal combustion engine, at least one of the valve lift of the intake valve and the valve operating angle of the intake valve in the second characteristic is larger than the corresponding at least one of the valve lift of the intake valve and the valve operating angle of the intake valve in the first characteristic.

4. The hybrid vehicle according to claim 1, wherein
the variable valve actuating device is configured to change the operation characteristic of the intake valve to any one of a first characteristic, a second characteristic and a third characteristic, and
the controller is configured to:
when the first driving mode is selected, control the variable valve actuating device such that the operation characteristic of the intake valve is set to the first characteristic at start-up of the internal combustion engine, and
when the second driving mode is selected, control the variable valve actuating device such that the operation characteristic of the intake valve is set to the third characteristic at start-up of the internal combustion engine, at least one of the valve lift of the intake valve and the valve operating angle of the intake valve in the second characteristic is larger than the corresponding at least one of the valve lift of the intake valve and the valve operating angle of the intake valve in the first characteristic, at least one of the valve lift of the intake valve and the valve operating angle of the intake valve in the third characteristic is larger than the corresponding at least one of the valve lift of the intake valve and the valve operating angle of the intake valve in the second characteristic.

5. The hybrid vehicle according to claim 1, wherein
the controller is configured to, when a process of stopping the internal combustion engine is executed, control the variable valve actuating device such that at least one of the valve lift of the intake valve and the valve operating angle of the intake valve when the first driving mode is selected is smaller than the corresponding at least one of the valve lift of the intake valve and the valve operating angle of the intake valve when the second driving mode is selected.

6. The hybrid vehicle according to claim 1, wherein
the controller is configured to:
when a process of stopping the internal combustion engine is executed, predict a driving mode that is selected at the next start-up of the internal combustion engine, and predict the driving mode on the basis of a condition of the vehicle and a driving mode that is selected at the time when the process of stopping the internal combustion engine is executed; and
control the variable valve actuating device during the process of stopping the internal combustion engine such that at least one of the valve lift of the intake valve and the valve operating angle of the intake valve when the predicted driving mode is the first driving mode is smaller than the corresponding at least one of the valve lift of the intake valve and the valve operating angle of the intake valve when the predicted driving mode is the second driving mode.

7. The hybrid vehicle according to claim 1, wherein
the controller is configured to, when a process of starting up the internal combustion engine is executed, control the variable valve actuating device such that at least one of the valve lift of the intake valve and the valve operating angle of the intake valve when the first driving mode is selected is smaller than the corresponding at least one of the valve lift of the intake valve and the valve operating angle of the intake valve when the second driving mode is selected.

8. The hybrid vehicle according to claim 1, further comprising:
an electrical storage device configured to store electric power for driving the rotary electric machine; and
a power generating mechanism configured to generate electric power for charging the electrical storage device by using output of the internal combustion engine, wherein
the controller is configured to:
when the second driving mode is selected, control travel of the vehicle such that an SOC of the electrical storage device is kept while the internal combustion engine is operated; and
when the first driving mode is selected, control travel of the vehicle such that the SOC decreases with an increase in travel distance.

9. The hybrid vehicle according to claim 1, further comprising:
an electrical storage device configured to store electric power for driving the rotary electric machine; and
a power generating mechanism configured to generate electric power for charging the electrical storage device by using output of the internal combustion engine, wherein
the controller is configured to:
select the first driving mode when an SOC of the electrical storage device is higher than a determination value; and
select the second driving mode when the SOC of the electrical storage device is lower than the determination value.

10. The hybrid vehicle according to claim 9, wherein
the controller is configured to:
when the second driving mode is selected, control travel of the vehicle such that the SOC of the electrical storage device is kept within a target range by operating the internal combustion engine; and
when the first driving mode is selected, control travel of the vehicle without operating the internal combustion engine for increasing the SOC.

11. The hybrid vehicle according to claim 9, further comprising:
an operation switch configured to allow a user to directly select one of the first driving mode and the second driving mode, wherein
the controller is configured to, when the operation switch is operated by the user, select one of the first driving mode and the second driving mode by giving a higher priority to input based on operation of the operation switch than selection based on the SOC.

12.-13. (canceled)
